(19) United States
(12) Patent Application Publication
(10) Pub. No.: US 2015/0168767 A1
(43) Pub. Date: Jun. 18, 2015

(54) DISPLAY DEVICE

(71) Applicant: Sharp Kabushiki Kaisha, Osaka (JP)

(72) Inventor: Koshu Yonemura, Osaka (JP)

(21) Appl. No.: 14/406,621

(22) PCT Filed: Jun. 4, 2013
(86) PCT No.: PCT/JP2013/065435

§ 371 Date: Dec. 9, 2014

(30) Foreign Application Priority Data
Jun. 11, 2012 (JP) 2012-131937

(51) Int. Cl. G02F 1/1333

(52) U.S. Cl. CPC G02F 1/133308

(57) ABSTRACT

A liquid crystal display device (display device) includes: a liquid crystal panel (display panel) that has a display surface for displaying images; a backlight device (lighting device) that is disposed on the reverse side of the liquid crystal panel from the display surface side, and emits light towards the liquid crystal panel; a cover panel that overlaps the liquid crystal panel on the display surface side, and has an outer edge portion that is disposed further to the outer side of the external peripheral edges of the liquid crystal panel; and a cover panel support frame (cover panel support member) that is provided separately from at least the backlight device, overlaps the outer edge portion of the cover panel on the liquid crystal panel side thereof, and has a substantially loop shape conforming to the outer edge portion.

### TECHNICAL FIELD

The present invention relates to a display device.

### BACKGROUND ART

In recent years, liquid crystal panels are used as display panels that display images in electronic devices such as in-vehicle information devices (in-car navigation systems and the like) or mobile information devices (mobile phones, smartphones, tablet PCs, and the like), and in some cases, cover panels are used to protect such liquid crystal panels. As an example of a liquid crystal display device using such a cover panel, one disclosed in Patent Document 1 below is known.

### RELATED ART DOCUMENTS

### Patent Documents

Patent Document 1: Japanese Patent Application Laid-Open Publication No. 2010-237493

### Problems to be Solved by the Invention

In the device disclosed in Patent Document 1, a backlight holder, which is a part of a backlight device that radiates illumination light to a liquid crystal panel, supports a cover panel, and external forces acting on the cover panel are directly received by the backlight holder, thus mitigating pooling in the liquid crystal panel.

However, the backlight holder has the function of holding optical parts such as the light guide plate and the light source while maintaining a constant positional relation therebetween, and thus, if the backlight holder receives stress from the cover panel, there is a risk that the backlight holder becomes deformed. If this happens, the positional relation between optical parts held by the backlight holder becomes offset, which causes unevenness in illumination light radiated from the backlight device to the liquid crystal panel, resulting in a deterioration in display quality in images displayed in the liquid crystal panel.

### SUMMARY OF THE INVENTION

The present invention was completed in view of such a situation, and an object thereof is to maintain high display quality in images displayed in a display panel.

### Means for Solving the Problems

A display device of the present invention includes: a display panel having a display surface that displays an image; an illumination device disposed on a side of the display panel opposite to the display surface, the illumination device radiating light to the display panel; a cover panel disposed to cover the display surface of the display panel, the cover panel having an outer edge portion disposed farther out than an outer edge of the display panel; and a cover panel support member having a substantially loop shape along the outer edge portion and being disposed on a same side of the outer edge portion of the cover panel as the display panel, the cover panel support member being not a part of at least the illumination device.

In this manner, the outer edge portion of the cover panel disposed on the display panel so as to overlap the display surface side is disposed further out than the outer edge of the display panel. Thus, if an external force acts on the outer edge portion, there is a concern that a large stress acts on the vicinity of the outer edge of the display panel. However, the outer edge portion of the cover panel is disposed so as to overlap the same side as the display panel, and is supported by a cover panel support member forming a substantially loop-shape along the outer edge portion, which means that at least a portion of the external force acting on the outer edge portion can be received by the cover panel support member. Thus, even if an external force acts on the outer edge portion of the cover panel, stress that might be transmitted from the outer edge portion to the vicinity of the outer edge of the display panel is mitigated, thereby making unlikely a situation in which display quality of images displayed in the display panel is reduced. Furthermore, the cover panel support member is provided separately from at least the illumination device, and thus, even if stress is transmitted from the outer edge portion of the cover panel to the cover panel support member, that stress can be prevented from being transmitted from the cover panel support member to the illumination device. As a result, negative effects on the optical performance of the illumination device is mitigated, thereby allowing the display quality of images displayed in the display panel to be maintained at a high level.

As embodiments of the present invention, the following configurations are preferred.

(1) A case member housing at least the display panel and the illumination device is further included, wherein the case member is provided with a support member attaching portion to which the cover panel support member is attached, the cover panel support member being sandwiched between the outer edge portion of the cover panel and the support member attaching portion. With this configuration, external force acting on the outer edge portion of the cover panel support member is received by the cover panel support member and by the support member attaching portion of the case member to which the cover panel support member is attached while being sandwiched between the cover panel support member and the outer edge portion of the cover panel. As a result, stress on the display panel can be further mitigated.

(2) The cover panel support member is formed in a continuous loop. With this configuration, the cover panel support member that supports the outer edge portion of the cover panel support member is a continuous loop with no breaks therein, and thus, compared to a case in which the loop has a discontinuity therein, the mechanical strength of the cover panel support member can be further increased. As a result, it is unlikely for the cover panel support member to deform as a result of an external force on the outer edge portion of the cover panel, and thus, it is possible to further mitigate stress that can occur on the display panel.

(3) The cover panel support member includes a main support member body having a substantially loop shape while being parallel to the outer edge portion, and a reinforcing portion that protrudes in a direction intersecting with a surface of the cover panel from an edge of the main support member body along the outer edge portion. With this configuration, the mechanical strength of the main support member body is improved by the reinforcing portion, and thus, the main support member body is unlikely to deform due to an external force acting on the outer edge portion of the cover panel, which can further suppress stress on the display panel.

(4) The reinforcing portion includes a first reinforcing portion that protrudes from an inner edge among the edges of the main support member body, the inner edge being relatively close to the display panel, and a second reinforcing portion that protrudes from an outer edge among the edges of the main support member body, the outer edge being relatively far from the display panel. With this configuration, by providing the first reinforcing portion and the second reinforcing portion respectively on the inner edge and the outer edge of the main support member body, it is possible to attain a greater reinforcing effect.

(5) The reinforcing portion is formed along almost an entire length of the edge of the main support body. With this configuration, a greater reinforcing effect can be attained by the reinforcing portion.

(6) The reinforcing portion protrudes from the edge of the main support member body towards a direction opposite to where the cover panel is provided. With this configuration, it is possible to guarantee sufficient protrusion of the reinforcing portion from the main support member body, and thus, it is possible to attain greater reinforcing effects.

(7) The reinforcing portion protrudes from at least the inner edge among the edges of the main support member body, the inner edge being relatively close to the display panel, the reinforcing portion facing outer edges of the display panel while being adjacent thereto. With this configuration, when attaching the cover panel support member and the display panel, the reinforcing portion protruding at least from the inner edge of the main support member body towards a direction opposite to the cover panel faces the outer edge of the display panel while being adjacent thereto, which allows the display panel to be positioned in directions along the surface thereof. As a result, the positional relation between the cover panel support member and the display panel can be made appropriate.

(8) The reinforcing portion is provided with a light-shielding portion that extends inward along a surface of the display panel, the light-shielding portion blocking light from the illumination device by being interposed between the outer edges of the display panel and the illumination device. With this configuration, by blocking light traveling towards the outer edge of the display panel from the illumination device by the light-shielding portion, it is possible to prevent unwanted light from being radiated on the outer edge of the display panel, which does not contribute to display.

(9) The illumination device is provided with a positioning portion disposed to face the reinforcing portion while being adjacent thereto from outside the reinforcing portion. With this configuration, when attaching the cover panel support member and the illumination device, the positioning portion of the illumination device faces the reinforcing portion while being adjacent thereto, and thus, the illumination device can be positioned with respect to the reinforcing portion and the display panel positioned by the reinforcing portion to be fixed in directions along the surface of the display panel. As a result, light from the illumination device can be more appropriately radiated on the display panel.

(10) The reinforcing portion includes a first reinforcing portion that protrudes from an inner edge among the edges of the main support member body, the inner edge being relatively close to the display panel, and a second reinforcing portion that protrudes from an outer edge among the edges of the main support member body, the outer edge being relatively far from the display panel, and the first reinforcing portion protrudes farther out from the main support member body than the second reinforcing portion. In this manner, when attaching the cover panel support member and the display panel, the first reinforcing portion, which protrudes from the main support member body to a greater degree than the second reinforcing portion, can more suitably fix the display panel in position. Also, a greater reinforcing effect can be attained by the first reinforcing portion and the second reinforcing portion.

(11) One end of a flexible substrate for transmitting image signals is connected to the display panel, and the reinforcing portion sandwiches the flexible substrate with the outer edges of the display panel. In this manner, when attaching the cover panel support member and the display panel, by disposing the flexible substrate connected to the display panel along the reinforcing portion, it is possible to draw out the other end of the flexible substrate through the space between the reinforcing portion and the outer edge of the display panel with ease, thereby allowing for excellent workability.

(12) A surface of the illumination device opposite to a surface facing the display panel is provided with a signal supplying substrate that supplies the image signals to the flexible substrate, another end of the flexible substrate being connected to the signal supplying substrate, and the reinforcing portion sandwiches the flexible substrate with the illumination device. With this configuration, by disposing the flexible substrate along the reinforcing portion, the other end of the flexible substrate can be drawn through the space between the reinforcing portion and the illumination device with ease to connect it to the signal supplying substrate, thereby allowing for excellent workability.

(13) The cover panel support member is made of sheet metal. With this configuration, compared to a case in which the cover panel support member is made of a synthetic resin or the like, the mechanical strength can be made greater.

(14) The display panel is a liquid crystal panel including a pair of substrates with liquid crystal sealed therebetween. Such a display device as a liquid crystal display device can be applied to various applications such as displays of devices such as in-vehicle information devices or mobile information devices, and is particularly suited to large screens.

### Effects of the Invention

According to the present invention, the display quality of images displayed in the display panel can be maintained at a high level.

### BRIEF DESCRIPTION OF THE DRAWINGS

FIG. 1 is an exploded perspective view schematically showing a liquid crystal display device according to Embodiment 1 of the present invention.

FIG. 2 is a cross-sectional view showing a schematic configuration of a liquid crystal display device.

FIG. 3 is a plan view of a cover panel to which a liquid crystal panel and a cover panel support frame is attached.

FIG. 4 a perspective view showing a state prior to the cover panel support frame being attached to the cover panel to which the liquid crystal panel is attached.

FIG. 5 is a perspective view showing a state prior to a backlight device being attached to the cover panel to which the liquid crystal panel and the cover panel support frame are attached.

FIG. 6 a perspective view showing a state prior to the cover panel support frame being attached to the cover panel to which the liquid crystal panel is attached according to Embodiment 2 of the present invention.

FIG. 7 is a cross-sectional view showing a schematic configuration of a liquid crystal display device.

FIG. 8 a perspective view showing a state prior to the cover panel support frame and the backlight device being attached to the cover panel to which the liquid crystal panel is attached according to Embodiment 3 of the present invention.

FIG. 9 is a cross-sectional view showing a schematic configuration of a liquid crystal display device, the cross-section being taken along the longer side direction of the liquid crystal display device.

FIG. 10 is a cross-sectional view showing a schematic configuration of a liquid crystal display device, the cross-section being taken along the shorter side direction of the liquid crystal display device.

FIG. 11 is a cross-sectional view of FIG. 9 along the line xi-xi.

FIG. 12 a cross-sectional view taken along the longer side direction showing a state prior to the cover panel support frame being attached to the cover panel to which the liquid crystal panel is attached.

FIG. 13 a cross-sectional view taken along the shorter side direction showing a state prior to the cover panel support frame being attached to the cover panel to which the liquid crystal panel is attached.

FIG. 14 a cross-sectional view taken along the longer side direction showing a state prior to the backlight device and a casing being attached to the cover panel to which the liquid crystal panel and the cover panel support frame is attached.

FIG. 15 a cross-sectional view taken along the shorter side direction showing a state prior to the backlight device and a casing being attached to the cover panel to which the liquid crystal panel and the cover panel support frame is attached.

FIG. 16 a perspective view showing a state prior to the cover panel support frame being attached to the cover panel to which the liquid crystal panel is attached according to Embodiment 4 of the present invention.

FIG. 17 is a cross-sectional view showing a schematic configuration of a liquid crystal display device.

FIG. 18 a perspective view showing a state prior to the cover panel support frame being attached to the cover panel to which the liquid crystal panel is attached according to Embodiment 5 of the present invention.

FIG. 19 is a cross-sectional view showing a schematic configuration of a liquid crystal display device.

FIG. 20 is a schematic cross-sectional view of a liquid crystal display device according to Embodiment 6 of the present invention.

FIG. 21 is a schematic cross-sectional view of a liquid crystal display device according to Embodiment 7 of the present invention.

FIG. 22 a perspective view showing a state prior to the cover panel support frame being attached to the cover panel to which the liquid crystal panel is attached according to Embodiment 8 of the present invention.

FIG. 23 a perspective view showing a state prior to the cover panel support frame being attached to the cover panel to which the liquid crystal panel is attached according to Embodiment 9 of the present invention.

FIG. 24 is a schematic cross-sectional view of a liquid crystal display device according to Embodiment 10 of the present invention.

### DETAILED DESCRIPTION OF EMBODIMENTS

### Embodiment 1

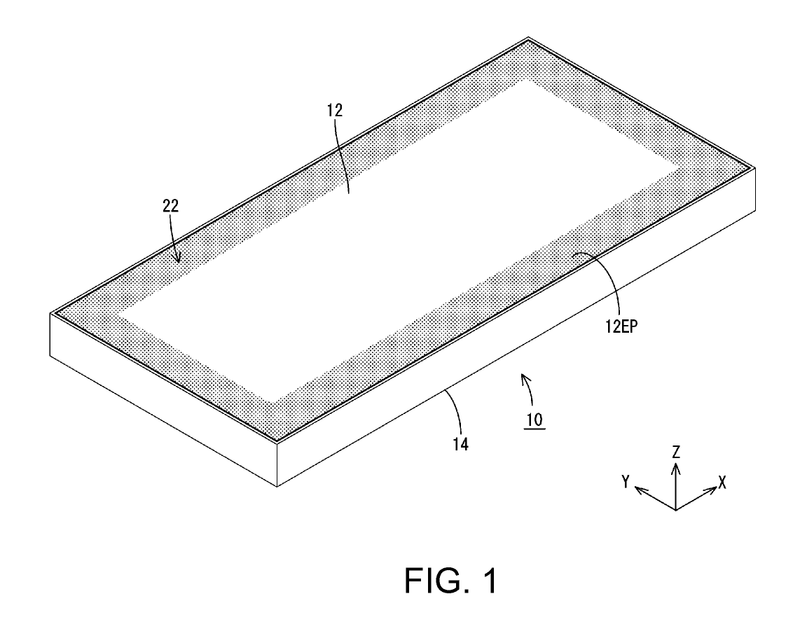

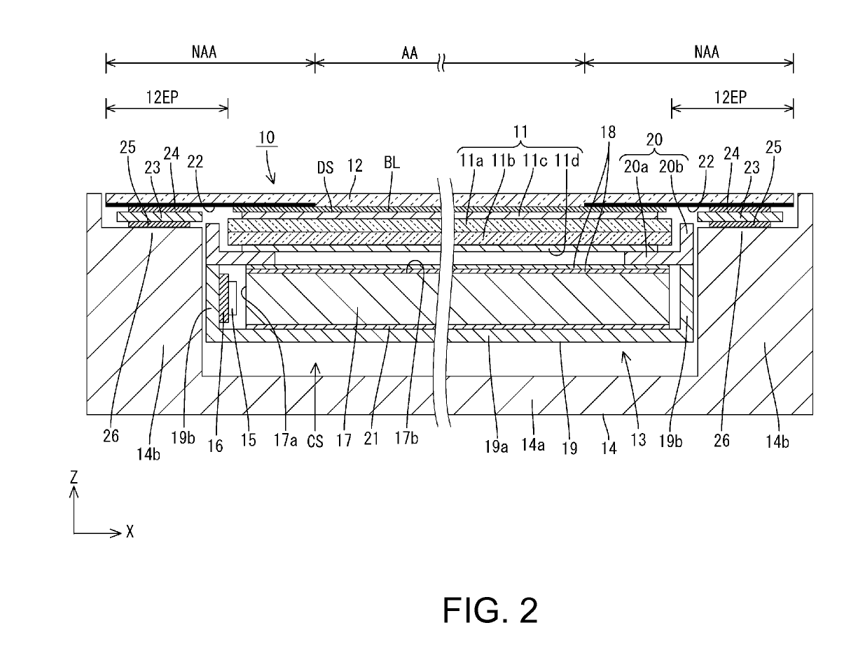

Embodiment 1 of the present invention will be described with reference to FIGS. 1 to 5. In the present embodiment, a liquid crystal display device 10 including a cover panel 12 will be described as an example. The drawings indicate an X axis, a Y axis, and a Z axis in a portion of the drawings, and each of the axes indicates the same direction for the respective drawings. The up and down direction is based on that of FIG. 2, and the upper side thereof is the front side while the lower side thereof is the rear side.

As shown in FIGS. 1 and 2, the liquid crystal display device 10 includes: a liquid crystal panel 11 (display panel) having an overall horizontally long rectangular shape, and having a display surface DS that displays images; a cover panel 12 disposed on the front of the liquid crystal panel 11, or in other words, the display surface DS; and a backlight device 13 (illumination device) that is an external light source that radiates light to the liquid crystal panel 11, the backlight device 13 being disposed on the rear of the liquid crystal panel 11, or in other words, the side opposite to the cover panel 12. Of these, the cover panel 12 is stacked on the front (display surface DS side, side towards which light is radiated) of the liquid crystal panel 11, and is bonded to the liquid crystal panel 11 through an adhesive layer BL, thereby integrating together the liquid crystal panel 11 and the cover panel 12. The liquid crystal display device 10 further includes a casing 14 (casing member, outer member) that houses the liquid crystal panel 11 and the backlight device 13. Of the components of the liquid crystal display device 10, the cover panel 12 and the casing 14 constitute the exterior of the liquid crystal display device 10. The liquid crystal display device 10 of the present embodiment is used in various electronic devices such as in-vehicle information devices (fixed car navigation systems, portable car navigation systems, and the like), mobile information devices (mobile phones, smartphones, tablet PCs, and the like), and portable gaming devices. Thus, the screen size of the liquid crystal panel 11 and the cover panel 12 constituting the liquid crystal display device 10 is from a few inches to a dozen inches, thereby categorizing the device generally as mid- to small-sized.

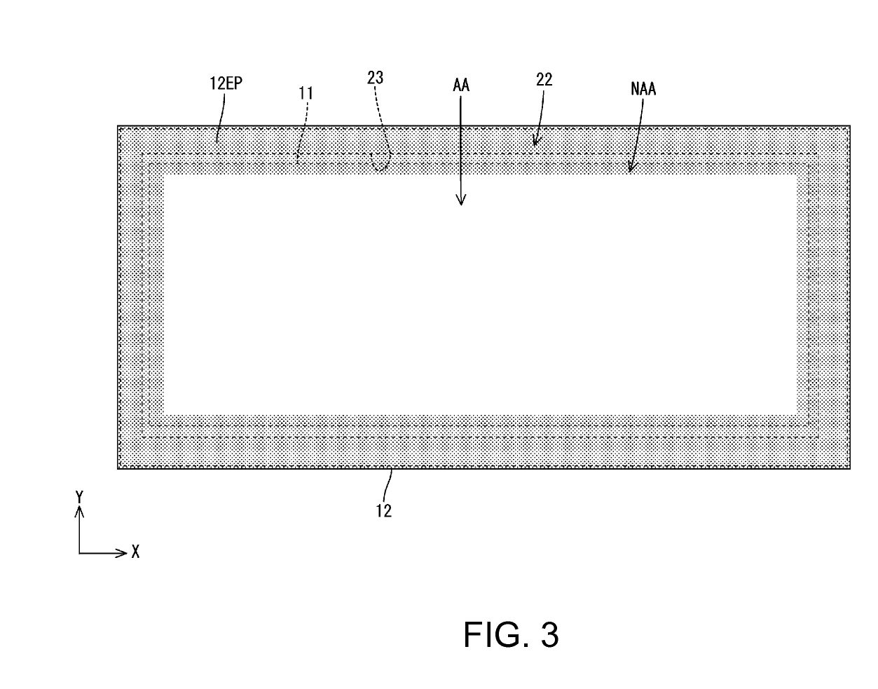

The liquid crystal panel 11 will be described. As shown in FIGS. 2 and 3, the liquid crystal panel 11 includes a pair of transparent (having light-transmissive qualities) glass substrates 11a and 11b having a horizontally long rectangular shape, and a liquid crystal layer (not shown) including liquid crystal molecules, which are a substance that changes optical properties in response to an applied electric field, the liquid crystal layer being interposed between the substrates 11a and 11b, and the substrates 11a and 11b are bonded together by a sealing member (not shown) maintaining a gap at a width equal to the thickness of the liquid crystal layer. The liquid crystal panel 11 has a display region AA that displays images (area inside solid line in FIG. 3) and a non-display region NAA surrounding the display region AA in a frame shape, where images are not displayed. The longer side direction of the liquid crystal panel 11 matches the X axis direction, and the shorter side direction thereof matches the Y axis direction.

Of the two substrates 11a and 11b, one on the front side (front surface side) is a CF substrate 11a, and the other on the rear side (rear surface side) is an array substrate 11b. A plurality of TFTs (thin film transistors), which are switching elements, and a plurality of pixel electrodes are provided on the inner surface of the array substrate 11b (surface facing the liquid crystal layer and opposing the CF substrate 11a), and gate wiring lines and source wiring lines surround each of these TFTs and pixel electrodes to form a grid pattern. Each of the wiring lines is fed a prescribed image signal from control circuits, which are not shown. The pixel electrode is a transparent electrode made of ITO (indium tin oxide) or ZnO (zinc oxide).

The CF substrate 11a has formed thereon a plurality of color filters in positions corresponding to the pixels. The color filters are arranged such that the three colors R, G, and B are alternately disposed. A light-shielding layer (black matrix) is formed between the color filters to prevent color mixing. An opposite electrode is provided on the surfaces of the color filters and the light-shielding layer so as to face the pixel electrodes on the array substrate 11b. The CF substrate 11a is formed to be slightly smaller than the array substrate 11b. Alignment films for aligning the liquid crystal molecules included in the liquid crystal layer are respectively formed on the inner surfaces of the substrates 11a and 11b. On the respective outer surfaces of the two substrates 11a and 11b, polarizing plates 11c and 11d are bonded.

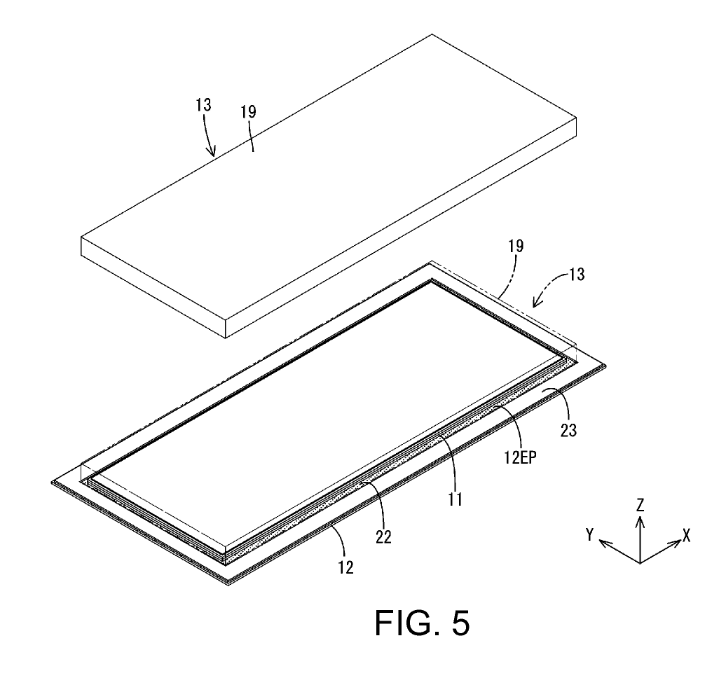

As shown in FIGS. 2 and 5, the backlight device 13 overall has a substantially block shape that is long in the horizontal direction in a manner similar to the liquid crystal panel 11. As shown in FIG. 2, the backlight device 13 includes: LEDs 15 (light emitting diodes), which are light sources; an LED substrate 16 on which the LEDs 15 are mounted; a light guide plate 17 that guides light from the LEDs 15; optical sheets 18 (optical members) layered on the light guide plate 17; a backlight chassis 19 that houses the LED substrate 16, the light guide plate 17, and the optical sheets 18; and a backlight frame 20 that, together with the backlight chassis 19, sandwiches the light guide plate 17 and the optical sheets 18. The backlight device 13 is of a so-called edge lit (side lit) type in which LEDs 15 are disposed on the edge face on the outer edge of the backlight device 13.

As shown in FIG. 2, each LED 15 has a configuration in which a LED chip is sealed by a resin material onto a substrate portion that is bonded to the surface of the LED substrate 16. The LED chip mounted on the substrate part has one type of primary light-emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of the LED chip and the fluorescent material causes white light to be emitted overall. The LED substrate 16 is attached to an edge of the backlight chassis 19 (side plate 19b to be mentioned later) such that the surface of the LED substrate 16 is perpendicular to the surface of the liquid crystal panel 11, and as a result, the optical axis of the LEDs 15 is substantially parallel to the surface of the liquid crystal panel 11.

As shown in FIG. 2, the light guide plate 17 has a horizontally long plate shape having a surface parallel to the surface of the liquid crystal panel 11, and the left edge face in FIG. 2 is a light-receiving face 17a that faces the LEDs 15, the light-receiving face 17a receiving light from the LEDs 15. Of the light guide plate 17, the surface facing the front (towards the liquid crystal panel 11) is a light-emitting surface 17b that emits light towards the front. Furthermore, a reflective sheet 21 is disposed so as to cover the rear surface of the light guide plate 17 (opposite to the light-emitting surface 17b), and the reflective sheet 21 causes light propagating through the light guide plate 17 to travel towards the front (light-emitting surface 17b). The optical sheets 18 are placed on the light-emitting surface 17b of the light guide plate 17, and are interposed between the liquid crystal panel 11 and the light guide plate 17, thus allowing light emitted from the light guide plate 17 therethrough while applying prescribed optical effects thereon, and emitting the light to the liquid crystal panel 11. A plurality of the optical sheets 18 (two in the present embodiment) are stacked one on top of the other. Specific types of optical sheets 18 include a diffusion sheet, a lens sheet, a reflective polarizing sheet, and the like, for example, and it is possible to appropriately choose any of these as optical sheets 18.

As shown in FIG. 2, the backlight chassis 19 is formed into a horizontally long substantially box shape having an open light-emitting portion facing the front (direction of light emission; towards the liquid crystal panel 11) by sheet metal working. The backlight chassis 19 has a bottom plate 19a having a horizontally long rectangular shape that supports the light guide plate 17 and the reflective sheet 20 from the rear, and four side plates 19b that rise towards the front from the four respective outer edges of the bottom plate 19a, and an LED substrate 16 is attached to the inner surface of a side plate 19b. The backlight frame 20, like the backlight chassis 19, is made of sheet metal, and includes a frame-shaped portion 20a having a substantially frame shape, and side plates 20b that rise towards the front from the four respective outer edges of the frame-shaped portion 20a. The frame-shaped portion 20a has a surface parallel to the surfaces of the liquid crystal panel 11 and the optical sheets 18, and, together with the bottom plate 19a of the backlight chassis 19, sandwiches the reflective sheet 21, the light guide plate 17, and the optical sheets 18, holding these in place. The backlight frame 20 is disposed to overlap the front of the outer edge portion of the backlight chassis 19, and is fixed in place by a prescribed fixing member (screws, welds, and the like).

As shown in FIGS. 2 and 3, the cover panel 12 is disposed to cover the entire front of the liquid crystal panel 11, thereby protecting the liquid crystal panel 11. The central portion of the rear surface of the cover panel 12 (portion surrounded by an outer edge portion 12EP to be mentioned later) has bonded thereto the liquid crystal panel 11 through an adhesive layer BL. Therefore, an air layer is prevented from forming between the cover panel 12 and the liquid crystal panel 11, and as a result, display quality of images is improved. It is preferable that the adhesive used in the adhesive layer BL be an ultraviolet curable resin material, for example. The cover panel 12 is made of a plate-shaped tempered glass having a high transparency, for example. It is preferable that the tempered glass used for the cover panel 12 be a chemically strengthened glass including a chemically strengthened layer on the surface by applying a chemical strengthening treatment on the surface of a plate-shaped glass base, for example. This chemical strengthening treatment uses ion exchange to strengthen the plate-shaped glass base by substituting an alkali metal ion contained in the glass material with an alkali metal ion that has a larger ion radius. The chemically strengthened layer resulting from this treatment is a compressive strength layer (ion exchange layer) that has residual compressive stress. As a result, the cover panel 12 has a high mechanical strength and shock resistance, thereby more reliably preventing damage or scratches on the liquid crystal panel 11 provided to the rear thereof.

The cover panel 12 has a horizontally long rectangular shape in a plan view, similar to the liquid crystal panel 11, and is slightly larger than the substrates 11a and 11b constituting the liquid crystal panel 11 in a plan view. Therefore, the cover panel 12 has an outer edge portion 12EP protruding out in an eve shape from the outer edges of the liquid crystal panel 11. The outer edge portion 12EP has a horizontally long substantially frame shape surrounding the liquid crystal panel 11. The cover panel 12 has formed thereon a light-shielding layer 22 that is disposed to surround the display region AA of the liquid crystal panel 11 and blocks light around the display region AA. The light-shielding layer 22 is made of a light-shielding material such as a black coating, for example, and this light-shielding material is printed onto the rear surface of the cover panel 12, or in other words, the surface facing the liquid crystal panel 11, and is thus integrally formed with this surface. When the light-shielding layer 22 is provided, printing methods such as screen printing, inkjet printing, or the like can be used, for example. The light-shielding layer 22 is disposed in a horizontally long substantially frame shape overlapping the non-display region NAA of the liquid crystal panel 11 and the outer edge portion 12EP in a plan view, and as a result, light from the backlight device 13 can be blocked by the light-shielding layer 22 prior to entering the rear of the cover panel 12 around the display region AA. The light-shielding layer 22 is shown with shading in FIGS. 1, 3, and 4, and the white rectangular region to the interior thereof is the display region AA. The area between the broken line indicating the outer shape of the liquid crystal panel 11 in FIG. 3 and the inner edge of the shaded portion (light-shielding layer 22) is the non-display region NAA.

The casing 14 is made of a synthetic resin, and as shown in FIGS. 1 and 2, has a horizontally long substantially box shape that is open towards the front. The casing 14 includes a bottom plate 14a forming a horizontally long rectangular shape, and side walls 14b forming a substantially square tube shape rising from the outer edges of the bottom plate 14a to the front. The inner space surrounded by the bottom plate 14a and the side walls 14b of the casing 14 has a housing space CS that houses at least the liquid crystal panel 11 and the backlight device 13 snugly. The bottom plate 14a covers the rear side (rear surface side) of the backlight device 13, whereas the side walls 14b surround the liquid crystal panel 11 and the backlight device 13 from the sides. The cover panel 12 covers almost the entire opening of the casing 14, and closes up this opening.

As shown in FIGS. 2 to 4, a cover panel support frame 23 (cover panel support member) that supports the outer edge portion 12EP, which is further outside than the outer edge of the liquid crystal panel 11, from the rear is attached to the cover panel 12 of the present embodiment. The cover panel support frame 23 is formed into a substantially loop-shape (substantially frame shape) along the outer edge portion 12EP by working a sheet metal (stainless steel sheet, zinc plated steel sheet, tin plated steel sheet, etc.) provided separately from the liquid crystal panel 11 and the backlight device 13. Specifically, the metal cover panel support frame 23 is formed in an continuous loop with no discontinuity therein, and has a horizontally long rectangular frame shape in a plan view. Therefore, the mechanical strength of the cover panel support frame 23 is maintained at a sufficiently high level, thereby firmly supporting the outer edge portion EP of the cover panel 12. It is preferable that the metal sheet forming the cover panel support frame 23 be 0.3 mm to 1.0 mm in thickness, for example, in order to ensure sufficient strength while guaranteeing ease of workability. The long and short dimensions of the cover panel support frame 23 are respectively longer than the long and short dimensions of the liquid crystal panel 11, and as a result, the outer edge of the liquid crystal panel 11 is to the inside of the inner edge of the cover panel support frame 23. In other words, the cover panel support frame 23 surrounds the liquid crystal panel 11 from an area outside the outer edge of the liquid crystal panel 11. Therefore, the cover panel support frame 23 is not in contact with the liquid crystal panel 11 or the backlight device 13, thus not being in mechanical contact therewith. As a result, the stress acting on the cover panel support frame 23 is very unlikely to be transmitted to the liquid crystal panel 11 and the backlight device 13. The cover panel support frame 23 if fixed to the rear surface of the outer edge portion 12EP of the cover panel 12, through a bonding layer 24. As a result, the cover panel support frame 23 is disposed on the same side of the outer edge portion 12EP of the cover panel 12 as the liquid crystal panel 11. The bonding layer 24 is overall formed in a horizontally long substantially frame shape in a plan view, and is disposed over the entire circumference of the cover panel support frame 23 and the outer edge portion 12EP. The bonding layer 24 is an adhesive (such as double-sided tape) or a bonding agent (such as a photocurable resin (ultraviolet curable resin, etc.) or the like).

As shown in FIG. 2, the cover panel support frame 23 is fixed by the bonding layer 25 to the casing 14 disposed to the rear of the cover panel support frame 23 (side opposite to the cover panel 12). Specifically, a support frame attaching portion 26 is formed in the casing 14 by forming a step-shaped indent in the tip of the side wall 14b rising up from the bottom plate 14a, and the cover panel support frame 23 is attached to this support frame attaching portion 26 through the bonding layer 25. In other words, the cover panel support frame 23 is sandwiched from the front and the rear by the outer edge portion 12EP of the cover panel 12 and the support frame attaching portion 26 of the casing 14 so as to be held in place. As a result, if a force is applied on the cover panel support frame 23 from the outer edge portion 12EP of the cover panel 12, this force can be received by the support frame attaching portion 26 of the casing 14. The bonding layer 25 is overall formed in a horizontally long substantially frame shape in a plan view, and is disposed over the entire circumference of the support frame attaching portion 26 and the outer edge portion 12EP. The bonding layer 25 is an adhesive (such as double-sided tape) or a bonding agent (such as a photocurable resin (ultraviolet curable resin, etc.) or the like).

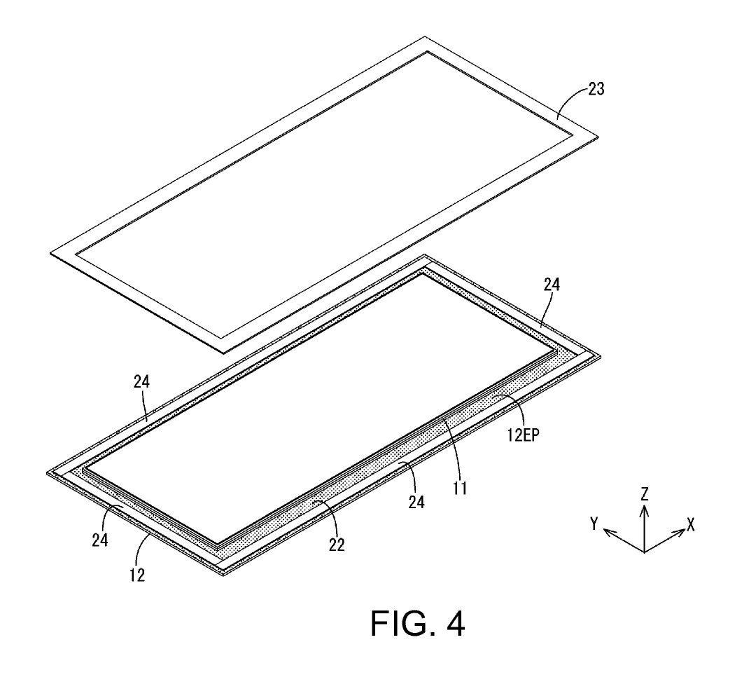

The present embodiment has the above-mentioned structure, and the operation thereof will be explained next. When assembling the liquid crystal panel 10, assembling steps (manufacturing processes) of the liquid crystal panel 11 and the backlight device 13 are done in advance. As shown in FIG. 4, when the liquid crystal panel 11 is bonded to the rear of the cover panel 12 through the adhesive layer BL, the cover panel support frame 23 is then attached to the cover panel 12. The bonding layer 24 is formed in advance on the rear surface of the cover panel 12 at the outer edge portion 12EP, and the cover panel support frame 23 is attached to the rear of the outer edge portion 12EP through the bonding layer 24. When the cover panel support frame 23 is bonded to the outer edge portion 12EP, then as shown in FIG. 5, the backlight device 13 is attached to the rear of the cover panel 12 and the liquid crystal panel 11. By attaching the support frame attaching portion 26 of the casing 14 through the bonding layer 25 to the cover panel support frame 23 attached to the cover panel 12, the assembly of the liquid crystal display device 10 shown in FIGS. 1 and 2 is completed.

When the liquid crystal display device 10 having this configuration is powered ON, the driving of the liquid crystal panel 11 is controlled by a panel control circuit (not shown), and the driving of the LEDs 15 on the LED substrate 16 is controlled by the LEDs 15 being supplied with driving power from the LED driver circuit (not shown). Light from the LEDs 15 enters the light-receiving face 17a of the light guide plate 17, is propagated through the light guide plate 17 and reflected by the reflective sheet 21, and then travels towards the front to exit from the light-emitting surface 17b. The light emitted from the light-emitting surface 17b is radiated to the liquid crystal panel 11 through the optical sheets 18, and as a result, a prescribed image is displayed in the liquid crystal panel 11.

If this liquid crystal display device 10 is used in various electronic devices such as an in-vehicle information device, a mobile information device, or a portable gaming device, shocks and vibrations can occur regularly depending on the usage environment. In particular, liquid crystal display devices 10 used as in-vehicle information devices are regularly subject to shock and vibration, and the external force operating thereon tends to be large. If such an external force operates on the outer edge portion 12EP of the cover panel 12 of the liquid crystal display device 10, then a large stress is applied to the vicinity of the outer edge of the liquid crystal panel 11 matching in position with the outer edge portion 12EP, and this can negatively affect images displayed in the liquid crystal panel 11 (so-called pooling). In the present embodiment, as shown in FIGS. 2 and 3, the cover panel support frame 23 having an continuous loop shape is stacked on the outer edge portion 12EP of the cover panel 12 on the same side as the liquid crystal panel 11, and thus, even if an external force is applied to the outer edge portion 12EP, a large portion of this force can be received by the cover panel support frame 23. As a result, it is possible to ease the stress that can occur in the vicinity of the outer edge of the liquid crystal panel 11 from the outer edge portion 12EP of the cover panel 12. Thus, it is possible to mitigate pooling as a result of changes in cell thickness (thickness of liquid crystal layer) in the vicinity of the outer edge of the liquid crystal panel 11 being unlikely to occur, and display quality of images can be maintained at a high level. Furthermore, the cover panel support frame 23 is provided as a separate unit from the backlight device 13 and is therefore not mechanically connected to the backlight device 13; thus, even if stress is transmitted to the cover panel support frame 23 from the outer edge portion 12EP of the cover panel 12, this stress can be prevented from being transmitted from the cover panel support frame 23 to the backlight device 13. As a result, optical parts constituting the backlight device 13 (LEDs 15, LED substrate 16, light guide plate 17, optical sheets 18, reflective sheet 21, and the like) are prevented from being offset with respect to each other, and thus, uneven luminance in illumination light radiated from the backlight device 13 to the liquid crystal panel 11 is made unlikely, and thus, the display quality of images displayed in the liquid crystal panel 11 can be maintained at a high level.

As shown in FIGS. 2 and 3, the cover panel support frame 23 is attached to the support frame attaching portion 26 of the casing 14 while being sandwiched with the outer edge portion 12EP of the cover panel 12, and thus, external force acting on the outer edge portion 12EP can be received by the support frame attaching portion 26 of the casing 14 along with the cover panel support frame 23. As a result, it is possible to further reduce stress that can occur in the vicinity of the liquid crystal panel 11 as a result of external force applied to the outer edge portion 12EP, and thus, it is possible to maintain display quality of images displayed in the display panel 11 at a high level. Furthermore, the cover panel support frame 23 is made of sheet metal formed in an continuous loop with no disconnection therein, and thus, compared to a case in which there is a disconnection in the cover panel support frame or a case in which the cover panel support frame is made of a synthetic resin, the mechanical strength can be maintained at a high level. As a result, the cover panel support frame 23 is less susceptible to deformation resulting from external force applied to the outer edge portion 12EP of the cover panel 12, and thus, it is possible to further mitigate stress on the liquid crystal panel 11.

As described above, the liquid crystal display device 10 (display device) of the present embodiment includes: a liquid crystal panel 11 (display panel) having a display surface DS that displays images; a backlight device 13 (illumination device) that is disposed on a side of the liquid crystal panel 11 opposite to the display surface DS, the backlight device 13 radiating light to the liquid crystal panel 11; a cover panel 12 stacked on the display surface DS side of the liquid crystal panel 11 and having the outer edge portion 12EP disposed further outside than the outer edges of the liquid crystal panel 11; and a cover panel support frame 23 (cover panel support member) having a loop shape along the outer edge portion 12EP, being provided separately from at least the backlight device 13, and being disposed on the same side of the outer edge portion 12EP of the cover panel 12 as the liquid crystal panel 11.

In this manner, the outer edge portion 12EP of the cover panel 12 disposed to overlap the display surface DS side of the liquid crystal panel 11 is disposed further to the outside than the outer edge of the liquid crystal panel 11. Thus, if an external force is applied to the outer edge portion 12EP, there is a concern that a large stress occurs in the vicinity of the outer edge of the liquid crystal panel 11. However, the outer edge portion EP of the cover panel 12 is supported by the loop-shaped cover panel support frame 23 disposed along the outer edge portion 12EP on the same side as the liquid crystal panel 11, and thus, at least a portion of the stress on the outer edge portion 12EP is received by the cover panel support frame 23. As a result, even if an external force operates on the outer edge portion 12EP of the cover panel 12, the stress that can be transmitted to the vicinity of the outer edge of the liquid crystal panel 11 from the outer edge portion 12EP is mitigated, thereby reducing the likelihood of a decrease in display quality in images displayed in the liquid crystal panel 11. Furthermore, the cover panel support frame 23 is provided separately from at least the backlight device 13, and thus, even if stress is transmitted from the outer edge portion 12EP of the cover panel 12 to the cover panel support frame 23, this stress can be prevented from being transmitted from the cover panel support frame 23 to the backlight device 13. As a result, negative effects on the optical properties of the backlight device 13 can be made unlikely, allowing display quality of images displayed in the liquid crystal panel 11 to be maintained at a high level.

A casing 14 (case member) housing at least the liquid crystal panel 11 and the backlight device 13 is included, and the casing 14 is provided with the support frame attaching portion 26 (support member attaching portion) to which the cover panel support frame 23 is attached while sandwiching the outer edge portion 12EP of the cover panel 12 therebetween. In this manner, the external force acting on the outer edge portion 12EP of the cover panel 12 is received by the cover panel support frame 23 and the support frame attaching portion 26 of the casing 14 to which the cover panel support frame 23 is attached while sandwiching the outer edge portion 12EP of the cover panel 12. As a result, stress on the liquid crystal panel 11 can be further mitigated.

Also, the cover panel support frame 23 is formed in an continuous loop. In this manner, the cover panel support frame 23 supporting the outer edge portion 12EP of the cover panel 12 is formed in an continuous loop with no disconnection therein, and thus, compared to a case in which there is a disconnection therein, the cover panel support frame 23 can be given greater mechanical strength. As a result, the cover panel support frame 23 is less susceptible to deformation resulting from external force applied to the outer edge portion 12EP of the cover panel 12, and thus, it is possible to further mitigate stress on the liquid crystal panel 11.

The cover panel support frame 23 is made of sheet metal. In this manner, compared to a case in which the cover panel support frame 23 is made of a synthetic resin or the like, a greater mechanical strength can be attained.

The liquid crystal panel 11 has liquid crystal sandwiched between a pair of substrates 11a and 11b. Such a display device as a liquid crystal display device 10 can be applied to various applications such as displays of devices such as in-vehicle information devices or mobile information devices, and is particularly suited to large screens.

### Embodiment 2

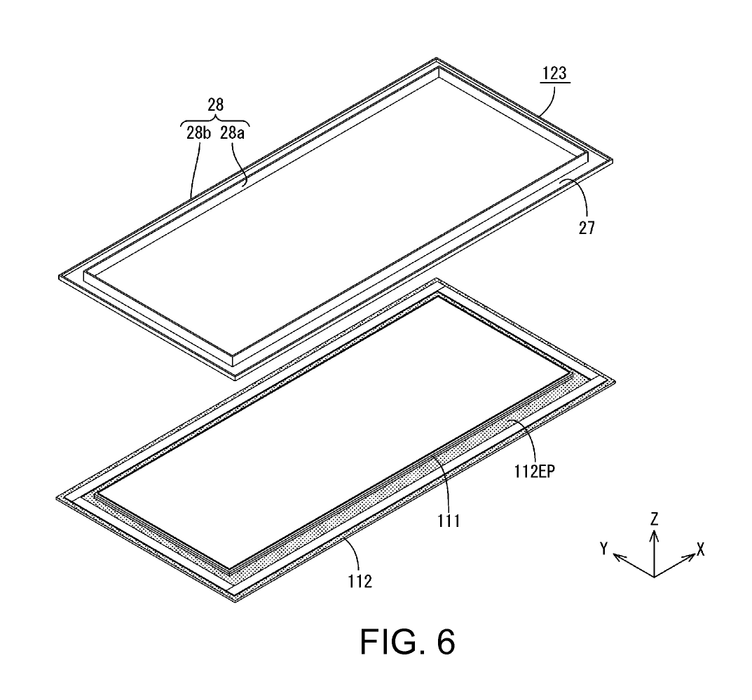

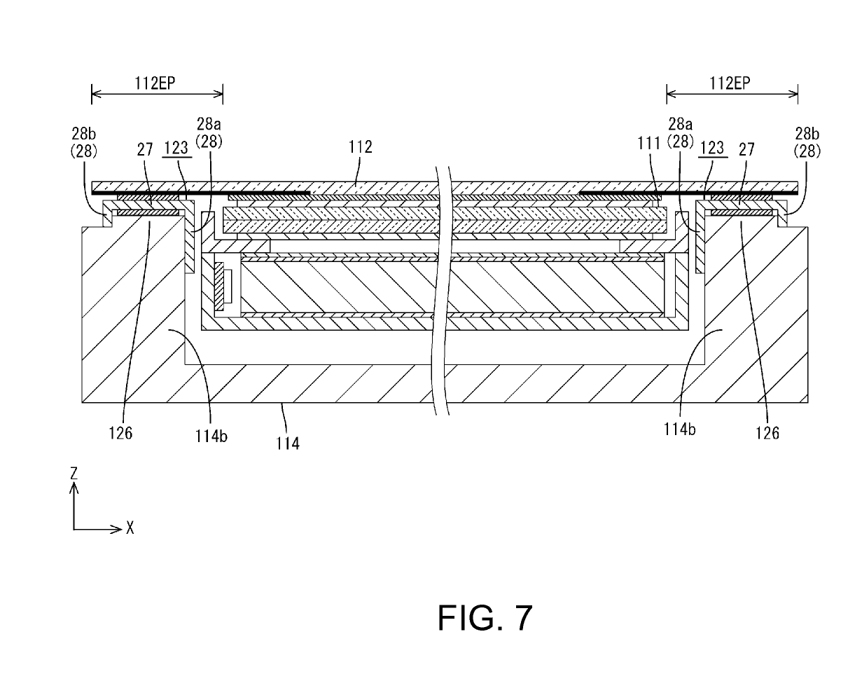

Embodiment 2 of the present invention will be described with reference to FIG. 6 or 7. The structure of a cover panel support frame 123 is modified in Embodiment 2. Descriptions of structures, operations, and effects similar to those of Embodiment 1 will be omitted.

As shown in FIGS. 6 and 7, the cover panel support frame 123 of the present embodiment includes a loop-shaped main support frame body 27 that is parallel to the outer edge portion 112EP of a cover panel 112, and a reinforcing portion 28 that protrude from the edges of the main support frame body 27 along the outer edge portion 112EP in the Z axis direction, or in other words, the direction perpendicular to the surface of the cover panel 112. In other words, the cover panel support frame 123 has a bend such that the cross-sectional shape thereof is in a channel shape, and the reinforcing portion 28 functions as a beam for mechanical reinforcement. The main support frame body 27 is formed in a rectangular frame that is horizontally long in a plan view, similar to the outer edge portion 112EP, and forms an continuous loop with no disconnection therein. The reinforcing portion 28 includes a first reinforcing portion 28a protruding from an inner edge portion of the main support frame body 27 close to the liquid crystal panel 111, and a second reinforcing portion 28b protruding from an outer edge of the main support frame body 27 that is relatively far from the liquid crystal panel 111. The first reinforcing portion 28a and the second reinforcing portion 28b are respectively provided to extend over the entire length of the inner and outer edges of the four sides (one pair of long sides and one pair of short sides) of the main support frame body 27, and respectively form a substantially square tube shapes overall. The first reinforcing portion 28a and the second reinforcing portion 28b protrude towards the rear from the inner and outer edges of the main support frame body 27, or in other words, towards the side opposite to the cover panel 112. In other words, the first reinforcing portion 28a and the second reinforcing portion 28b protrude while being parallel to each other in the same direction along the Z axis direction. The first reinforcing portion 28a has a larger dimension of protrusion from the main support frame body 27 than the second reinforcing portion 28b. The support frame attaching portion 126 of the casing 114 is sandwiched between the first reinforcing portion 28a and the second reinforcing portion 28b. The first reinforcing portion 28a is in contact with the inner wall face of the side wall 114b of the casing 114.

By providing the reinforcing portion 28 in the cover panel support frame 123, the mechanical strength of the main support frame body 27, which supports the outer edge portion 112EP of the cover panel 112 from the rear, becomes greater, and thus, deformation of the main support frame body 27 due to an external force acting on the outer edge portion 112EP of the cover panel 112 can be further mitigated. Furthermore, the reinforcing portion 28 include the first reinforcing portion 28a and the second reinforcing portion 28b provided respectively along the entire length of the inner and outer edges of the main support frame body 27, and thus, the mechanical strength of the main support frame body 27 can be made even greater. Thus, it is possible to mitigate stress on the liquid crystal panel 11 that can result from an external force acting on the outer edge portion 112EP of the cover panel 112, and thus, it is possible to further improve display quality of images displayed in the liquid crystal panel 111.

As described above, according to the present embodiment, the cover panel support frame 123 includes a main support frame body 27 (main support member body) having a substantially loop shape parallel to the outer edge portion 112EP, and the reinforcing portion 28 that protrudes in a direction intersecting with the surface of the cover panel 112 from an edge along the outer edge portion 112EP of the main support frame body 27. In this manner, it is possible to improve the mechanical strength of the main support frame body 27 due to the reinforcing portion 28, and thus, the main support frame body 27 is less susceptible to being deformed due to an external force acting on the outer edge portion 112EP of the cover panel 112, and thus, it is possible to further mitigate stress on the liquid crystal panel 111.

The reinforcing portion 28 includes the first reinforcing portion 28a protruding from the inner edge portion of the main support frame body 27 relatively close to the liquid crystal panel 111, and the second reinforcing portion 28b protruding from the outer edge of the main support frame body 27 relatively far from the liquid crystal panel 111. In this manner, by providing the first reinforcing portion 28a and the second reinforcing portion 28b respectively on the inner edge and outer edge of the main support frame body 27, it is possible to further increase the reinforcing effect.

Also, the reinforcing portion 28 is formed along almost the entire length of the edge. In this manner, the reinforcing effect of the reinforcing portion 28 can be further increased.

Also, the reinforcing portion 28 protrudes from the edges of the main support frame body 27 towards a direction opposite to the cover panel 112. In this manner, it is possible to guarantee sufficient protrusion of the reinforcing portion 28 from the main support frame body 27, and thus, it is possible to attain greater reinforcing effects.

### Embodiment 3

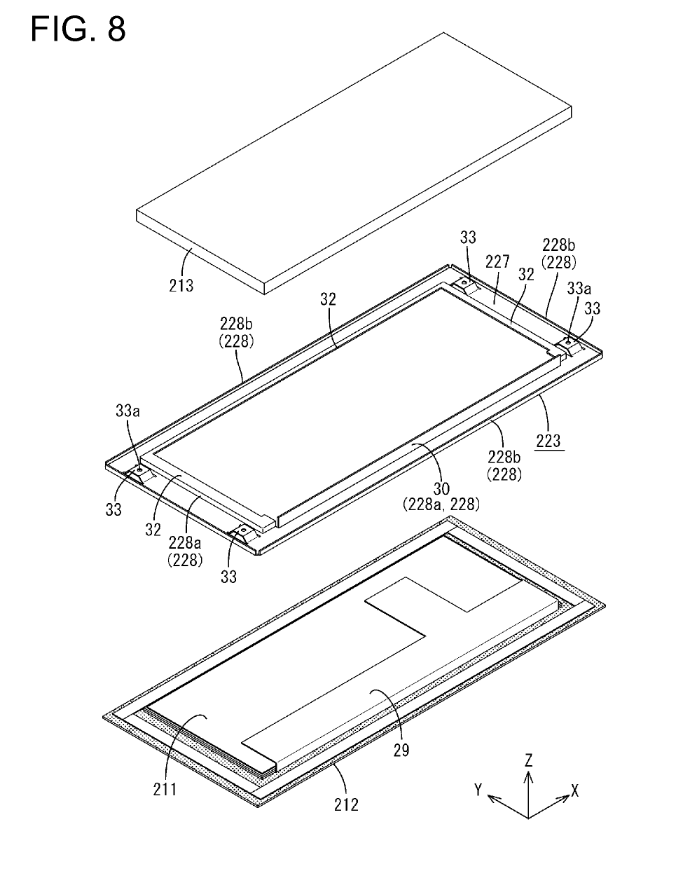

Embodiment 3 of the present invention will be described with reference to FIGS. 8 to 15. The structure of the cover panel support frame 223 in Embodiment 3 is modified from that of Embodiment 2. Descriptions of structures, operations, and effects similar to those of Embodiments 1 and 2 will be omitted.

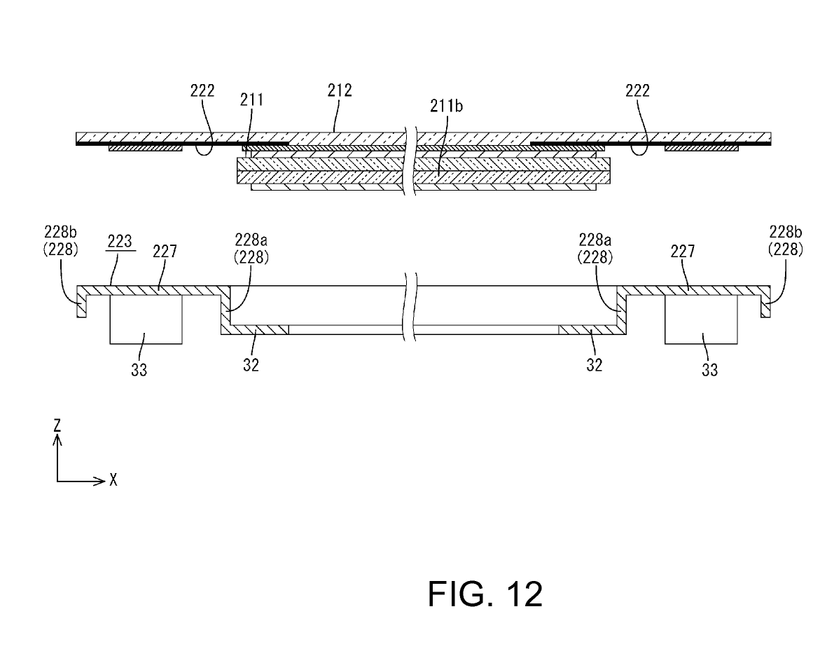

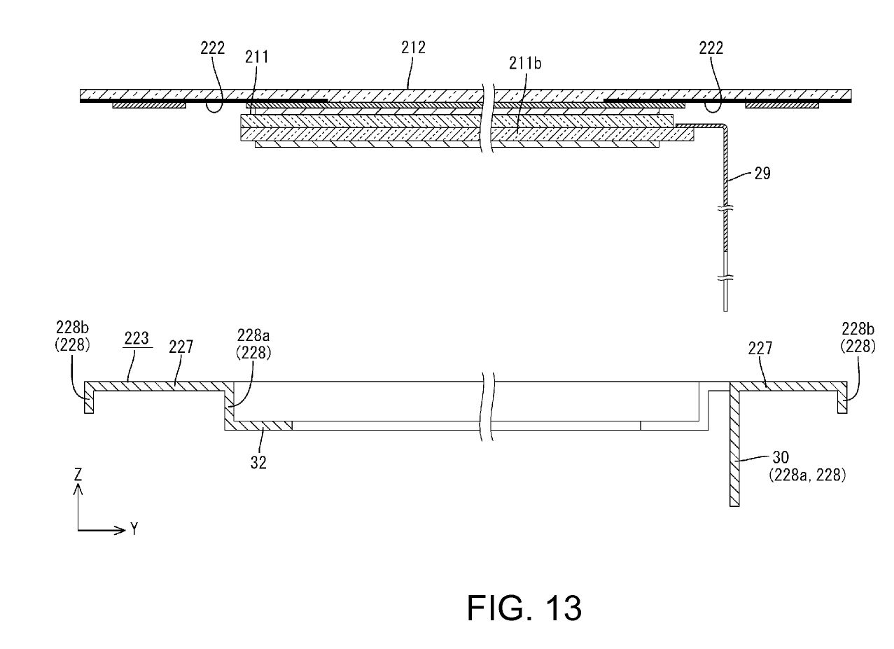

As shown in FIGS. 8 to 10, reinforcing portion 228 provided on the cover panel support frame 223 of the present embodiment has the function of positioning the cover panel support frame 223 with respect to the liquid crystal panel 211 (cover panel 212) and the backlight device 213. Specifically, the first reinforcing portion 228a, which is a part of the reinforcing portion 228 protruding towards the rear in the Z axis direction from the inner edge of the main support frame body 227, is provided to face the outer edge of the liquid crystal panel 211 while being adjacent thereto. In other words, the first reinforcing portion 228a surrounds the entire outer edge of the liquid crystal panel 211, and thus, when attaching the cover panel support frame 223 to the liquid crystal panel 211 and the cover panel 212, the inner surface of the first reinforcing portion 228a abuts the outer edge of the liquid crystal panel 211 as shown in FIGS. 12 and 13, and therefore, it is possible to fix the cover panel support frame 223 in the X axis direction and the Y axis direction with respect to the liquid crystal panel 211 and the cover panel 212.

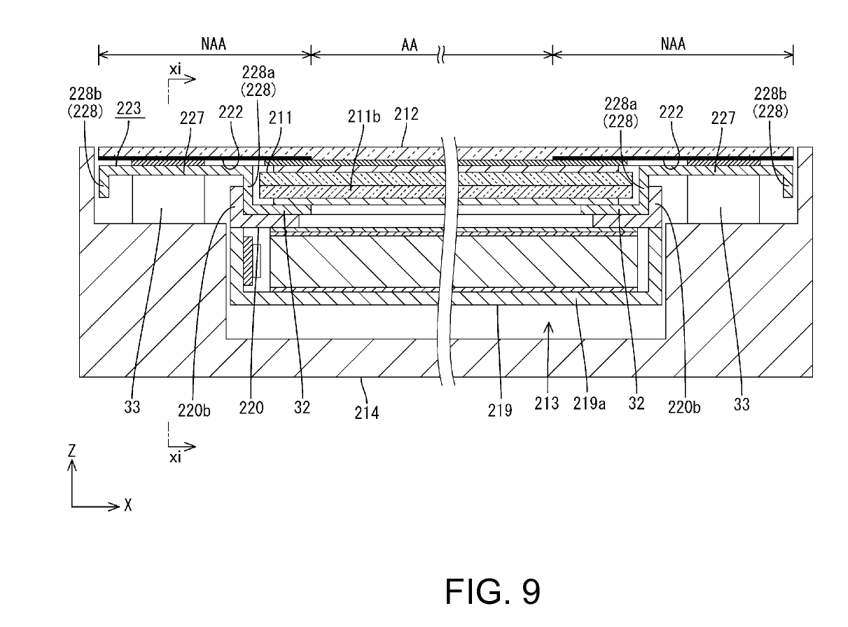

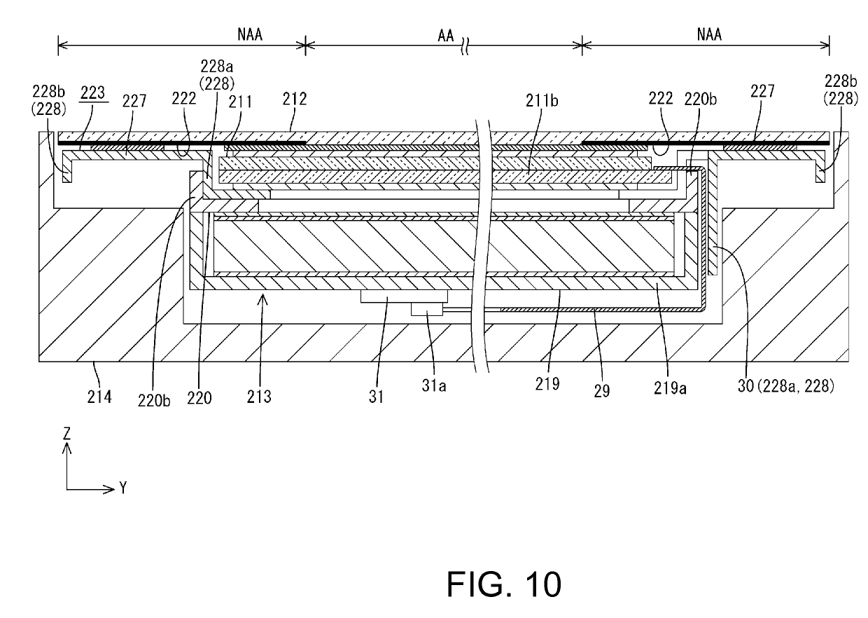

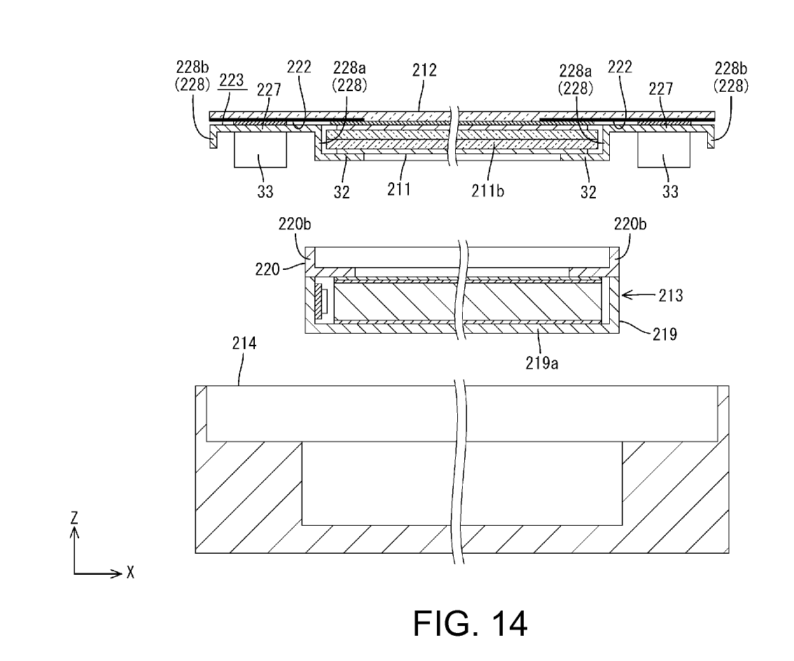

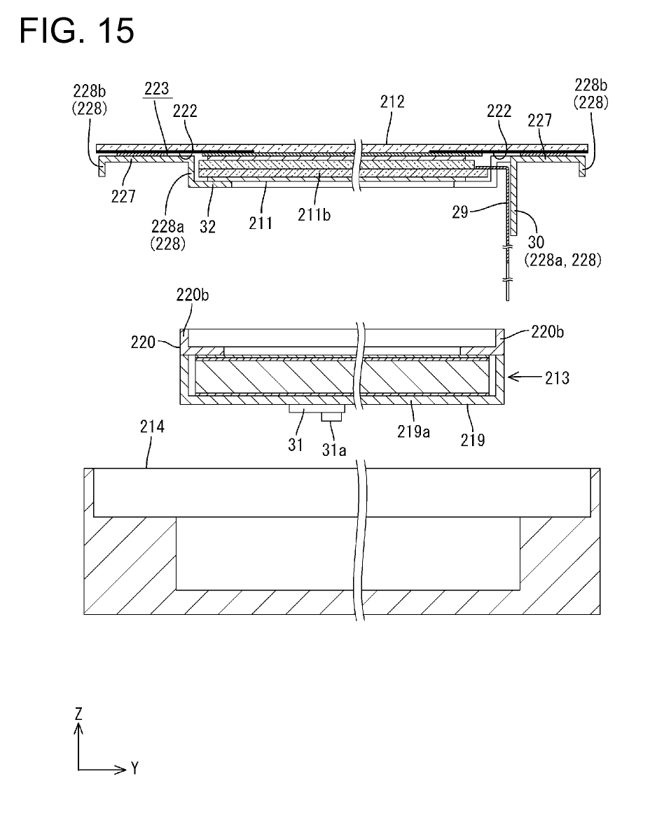

As shown in FIGS. 9 and 10, the first reinforcing portion 228a is disposed to face the inner side (liquid crystal panel 211 side) of the side plate 220b of the backlight frame 220 included in the backlight device 213. In other words, the first reinforcing portion 228a is sandwiched from the inside and the outside between the outer edge of the liquid crystal panel 211 and the side plate 220b of the backlight frame 220. The surface of the side plate 220b facing this inner face is disposed to oppose the first reinforcing portion 228a, and constitutes the “positioning portion” for positioning with respect to the cover panel support frame 223. The side plate 220b surrounds the entire periphery of the first reinforcing portion 228a from the outside, and thus, when attaching the backlight device 213 to the cover panel support frame 223, as shown in FIGS. 14 and 15, the inner surface of the side plate 220b of the backlight frame 220 abuts the outer side face of the first reinforcing portion 228a, and thus, the backlight device 213 can be positioned with respect to the cover panel support frame 223 in the X axis direction and the Y axis direction.

Further, as shown in FIGS. 8 and 10, the first reinforcing portion 228a includes a guide reinforcing portion 30 having a guiding function for a flexible substrate 29 connected to the liquid crystal panel 211. The flexible substrate 29 has formed thereon conductive paths (wiring patterns) on a film-shaped base material made of a synthetic resin that is insulating and flexible. One edge of the flexible substrate 29 is connected by pressure onto the outer edge of one long side of the array substrate 211b of the liquid crystal panel 211 through an anisotropic conductive film (not shown), whereas the other edge of the flexible substrate 29 is connected to a control substrate 31 attached to the rear surface of the backlight chassis 219 of the backlight device 213. The control substrate 31 has a panel control circuit that supplies image signals to the liquid crystal panel 211 to control the driving thereof, and has a connector 31a into which the other edge of the flexible substrate 29 is inserter. The flexible substrate 29 is bent twice at almost a perpendicular angle due to the fact that the liquid crystal panel 211 is connected to the control substrate 31 with the backlight device 213 therebetween, and thus, it is possible to transmit the image signals from the control substrate 31 to the respective wiring lines of the liquid crystal panel 211.

As shown in FIGS. 8 and 10, the guide reinforcing portion 30 includes one first reinforcing portion 228a facing the flexible substrate 29 from outside, among the four first reinforcing portions 228a respectively provided on the four inner edges of the main support frame body 227. The guide reinforcing portion 30 protrudes further out from the main support frame body 227 than the other first reinforcing portions 228a, and the tip of the protrusion reaches the vicinity of the bottom plate 219a of the backlight chassis 219. Therefore, the guide reinforcing portion 30 and the outer edge of the liquid crystal panel 211 sandwich the flexible substrate 29 and the guide reinforcing portion 30 and the outer side face of the backlight device 213 sandwich the flexible substrate 29. As a result, when the cover panel support frame 223 is attached to the liquid crystal panel 211 and the cover panel 212, as shown in FIG. 13, the flexible substrate 29 connected to the liquid crystal panel 211 is in contact with the guide reinforcing portion 30, and thus, the flexible substrate 29 can be drawn smoothly to the rear of the cover panel support frame 223. Additionally, when attaching the backlight device 213 to the cover panel support frame 223, as shown in FIG. 15, the flexible substrate 29 is in contact with the guide reinforcing portion 30, and thus, components of the backlight device 213 to which the flexible substrate 29 is attached (backlight frame 220 and the like) are less likely to be stuck on the flexible substrate 29, thereby allowing it to be smoothly attached to the backlight device 213.

As shown in FIGS. 8 and 10, a light-shielding portion 32 that blocks light from the backlight device 213 by extending inward along the surface of the liquid crystal panel 211 and by being interposed between the outer edge of the liquid crystal panel 211 and the backlight device 213 is provided on a protruding tip of the first reinforcing portion 228a (tip thereof on the side opposite to the main support frame body 227). The light-shielding portions 32 are provided on the protruding tips of three first reinforcing portions 228a among the four first reinforcing portions 228a, to the exclusion of the guide reinforcing portion 30. The light-shielding portions 32 are provided to face the three sides of the liquid crystal panel 211 from the rear thereof. The light-shielding portions 32 are disposed to overlap the light-shielding layer 222 of the cover panel 212 and the non-display region NAA of the liquid crystal panel 211 in a plan view. As a result, of the light radiated from the backlight device 213 to the liquid crystal panel 211, light not used for display in the display region AA of the liquid crystal panel 211 can be blocked by the light-shielding portions 32 prior to the light reaching the light-shielding layer 222. In other words, unwanted light can be blocked twice by the light-shielding portions 32 and the light-shielding layer 222, allowing for great light-shielding characteristics, and thus, it is possible to further increase the display quality of images displayed in the display region AA. Also, the first reinforcing portion 228a protrudes further from the main support frame body 227 than the second reinforcing portion 228b, and is therefore suited to positioning with respect to the liquid crystal panel 211 and the backlight device 213 with greater ease.

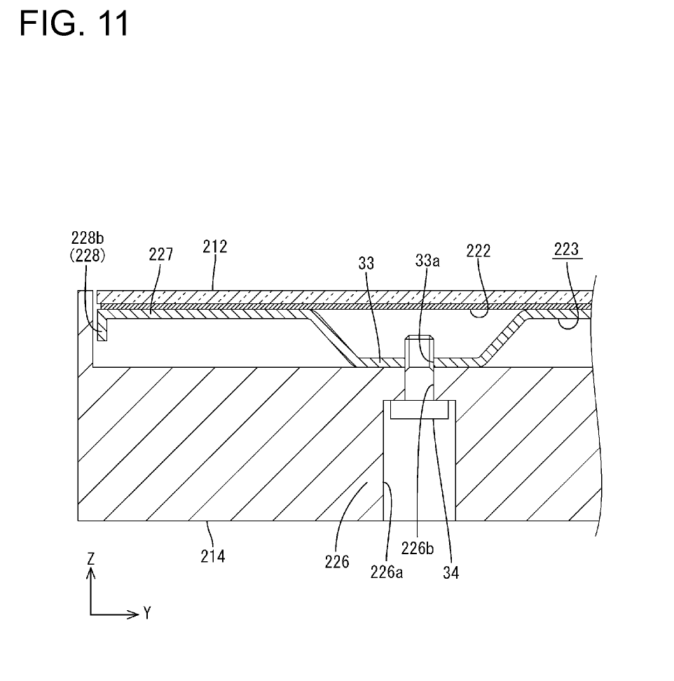

Besides this, in the present embodiment, the attaching structure of the cover panel support frame 223 and the casing 214 is modified. Specifically, as shown in FIGS. 8 and 11, main support frame body 227 of the cover panel support frame 223 is provided with screw attaching portions 33 for attaching the support frame attaching portion 226 of the casing 214 thereto using screw members 34, the screw attaching portions 33 partially protruding towards the rear. The screw attaching portions 33 are formed in a double-beam structure overall by partially cutting and raising respective edges of a pair of long sides of the main support frame body 227, and in the center of the screw attaching portion 33, a hole 33a for passing the shaft of the screw member 34 is formed in the center thereof. The support frame attaching portion 226 of the casing 214 has formed therein a screw housing opening 226a for housing the head of the screw member 34, and a hole 226b for the shaft of the screw member 34 is formed in the center of the screw housing opening 226a. Thus, the cover panel support frame 223 and the casing 214 can be stably held together by screw members 34 provided respectively in the vicinity of the four corners thereof.

As described above, in the present embodiment, the reinforcing portion 228 protrudes at least from an inner edge of the main support frame body 227 relatively close to the liquid crystal panel 211, and faces the outer edge of the liquid crystal panel 211. In this manner, when attaching together the cover panel support frame 223 and the liquid crystal panel 211, the reinforcing portion 228 that protrudes at least from the inner edge of the main support frame body 227 towards a direction opposite to the cover panel 212 faces the outer edge of the liquid crystal panel 211, and thus, it is possible to fix the liquid crystal panel 211 in place with respect to the surface of the reinforcing portion 228. In this manner, it is possible to appropriately position the cover panel support frame 223 and the liquid crystal panel 211 with respect to each other.

Also, the reinforcing portions 228 are provided with light-shielding portions 32 that block light from the backlight device 213 by being provided between the outer portion of the liquid crystal panel 211 and the backlight device 213 and by extending inward from the surface of the liquid crystal panel 211. In this manner, by using the light-shielding portions 32 to block light traveling towards the outside edges of the liquid crystal panel 211 from the backlight device 213, it is possible to prevent unwanted light from being radiated to the outer edges of the liquid crystal panel 211, which do not contribute to display.

Also, the backlight device 213 is provided with side plates 220b (positioning portions) facing the reinforcing portions 228 from outside. In this manner, when attaching together the cover panel support frame 223 and the backlight device 213, the side plates 220b of the backlight device 213 face the reinforcing portions 228 from the outside, and thus, the backlight device 213 can be fixed in position with respect to the reinforcing portions 228 and the liquid crystal panel 211 positioned by the reinforcing portions 228, in a direction along the surface of the liquid crystal panel 211. As a result, the light from the backlight device 213 can be radiated more appropriately to the liquid crystal panel 211.

Also, the reinforcing portions 228 include the first reinforcing portions 228a protruding from the inner edges of the main support frame body 227, which are relatively close to the liquid crystal panel 211, and the second reinforcing portions 228b that protrude from outer edges of the main support frame body 227, which are relatively far from the liquid crystal panel 211, and the first reinforcing portions 228a protrude further from the main support frame body 227 than the second reinforcing portions 228b. In this manner, when attaching the cover panel support frame 223 to the liquid crystal panel 211, the first reinforcing portions 228a, which protrude to a greater degree from the main support frame body 227 than the second reinforcing portions 228b, can more suitably position the liquid crystal panel 211. Also, a greater reinforcing effect can be attained by the first reinforcing portions 228a and the second reinforcing portions 228b.

Also, the liquid crystal panel 211 has connected thereto one edge of the flexible substrate 29 for transmitting image signals, and the reinforcing portion 228 is disposed to sandwich the flexible substrate 29 with the outer edge of the liquid crystal panel 211. In this manner, when attaching together the cover panel support frame 223 and the liquid crystal panel 211, the flexible substrate 29 connected to the liquid crystal panel 211 is disposed along the reinforcing portion 228, thereby allowing the other edge of the flexible substrate 29 to be drawn with ease through the area between the reinforcing portion 228 and the outer edge of the liquid crystal panel 211, which improves workability.

The surface of the backlight device 213 opposite to the liquid crystal panel 211 side is provided with a control substrate 31 (signal supplying substrate) that supplies image signals to the flexible substrate 29 while being connected to the other edge of the flexible substrate 29, and the reinforcing portion 228 sandwiches the flexible substrate 29 with the backlight device 213. In this manner, by having the flexible substrate 29 be disposed along the reinforcing portion 228, the other edge of the flexible substrate 29 can be passed with ease between the reinforcing portion 228 and the backlight device 213 to be connected to the control substrate 31, allowing high workability.

### Embodiment 4

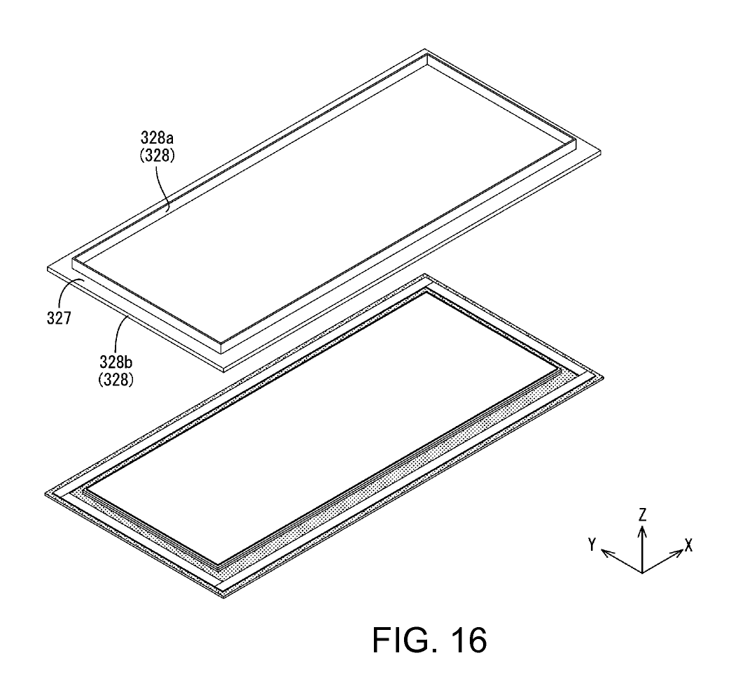

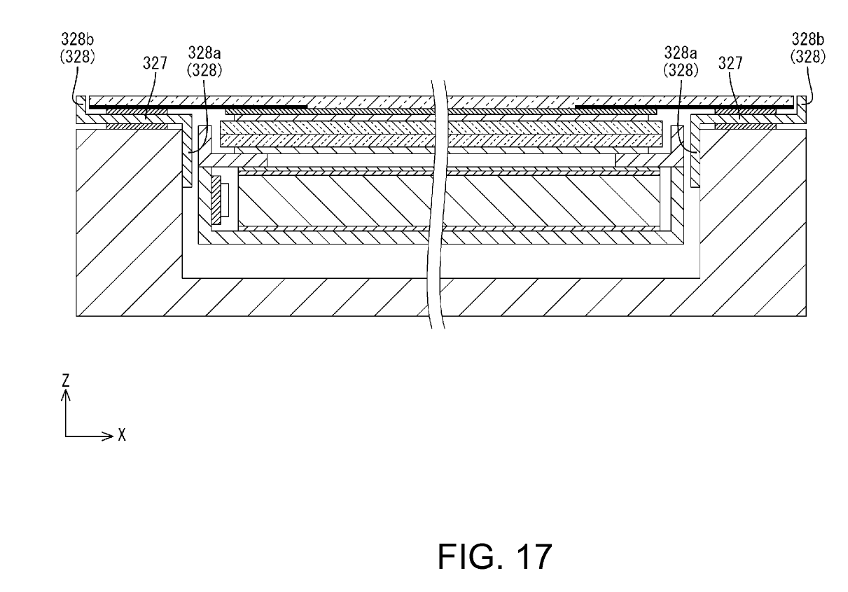

Embodiment 4 of the present invention will be described with reference to FIG. 16 or 17. Embodiment 4 shows a case in which the structure of the reinforcing portions 328 differs from that of Embodiment 4. Descriptions of structures, operations, and effects similar to those of Embodiment 2 will be omitted.

As shown in FIGS. 16 and 17, second reinforcing portions 328b included among the reinforcing portions 328 are provided to protrude towards the front from a main support frame body 327 in the Z axis direction. In other words, the second reinforcing portions 328b protrude towards a direction opposite to first reinforcing portions 328a. Even with such a structure, reinforcing effects similar to the pair of inner and outer reinforcing portions 328a and 328b in Embodiment 2 can be achieved.

### Embodiment 5

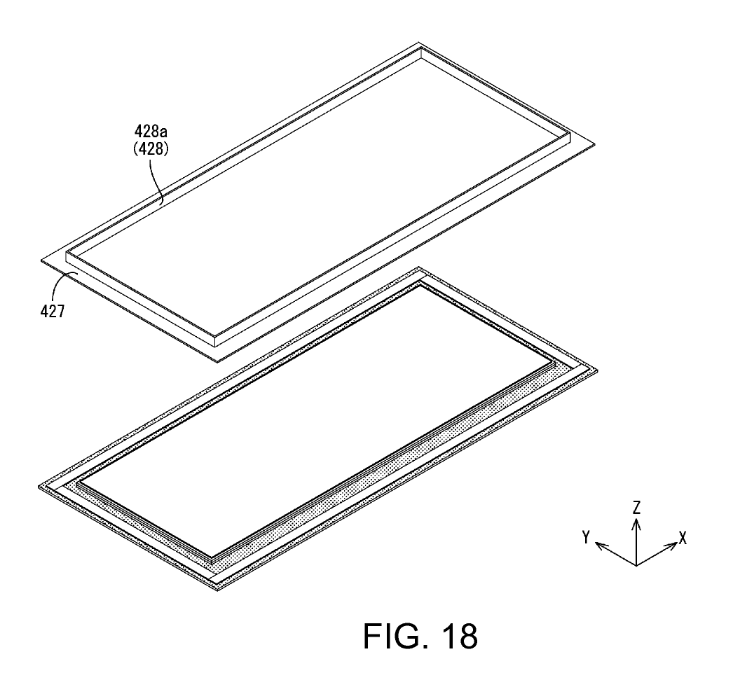

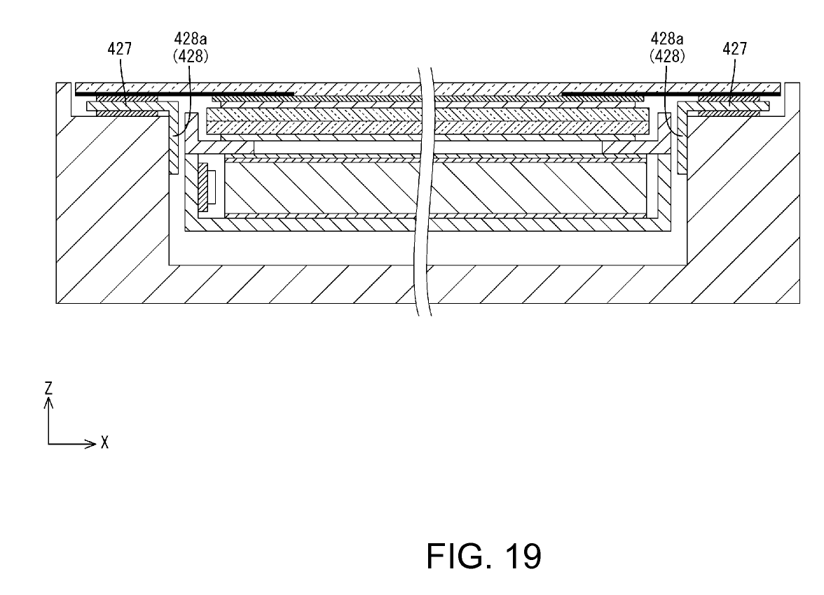

Embodiment 5 of the present invention will be described with reference to FIG. 18 or 19. Embodiment 5 shows a case in which the structure of the reinforcing portion 428 differs from that of Embodiment 2. Descriptions of structures, operations, and effects similar to those of Embodiment 2 will be omitted.

As shown in FIGS. 18 and 19, the reinforcing portion 428 of the present embodiment does not include a second reinforcing portion included in Embodiment 2, and includes only a first reinforcing portion 428a. In other words, the reinforcing portion 428 includes only a first reinforcing portion 428a that protrudes towards the rear from the inner edges of the main support frame body 427 along the Z axis direction. Even with such a configuration, the main support frame body 427 can be reinforced by the first reinforcing portions 428a.

### Embodiment 6

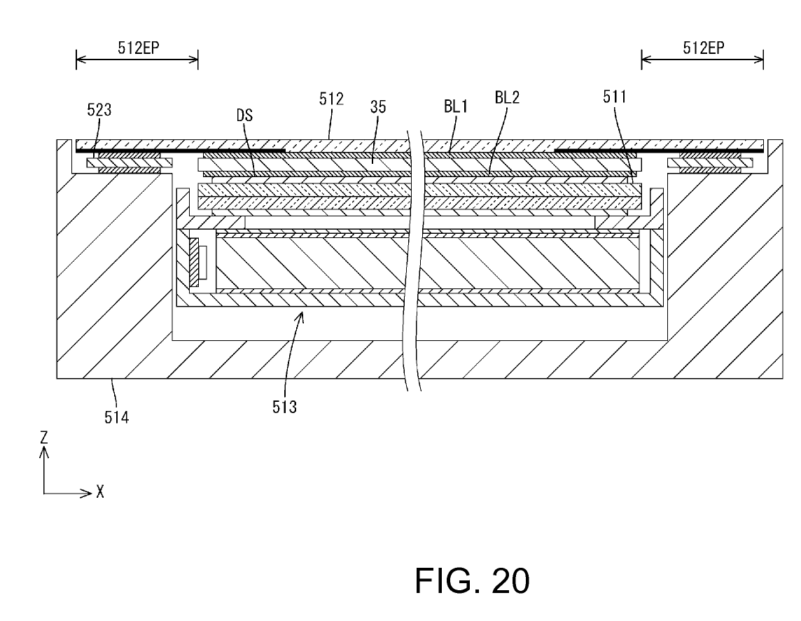

Embodiment 6 of the present invention will be described with reference to FIG. 20. In Embodiment 6, a touch panel 35 is additionally provided. Descriptions of structures, operations, and effects similar to those of Embodiment 1 will be omitted.

As shown in FIG. 20, the touch panel 35 is interposed between a cover panel 512 and a liquid crystal panel 511 of the present embodiment. The touch panel 35 is a position input device that allows a user to input position information on the plane of the display surface DS of the liquid crystal panel 511, and a prescribed touch panel pattern (not shown) is formed on the almost transparent glass substrate. Specifically, the touch panel 35 has a glass substrate having a horizontally long rectangular shape in a manner similar to the liquid crystal panel 511, and has formed thereon transparent electrodes (not shown) for the touch panel constituting a so-called projection-type capacitive touch panel pattern on the front surface thereof. The front surface of the touch panel 35 is attached to the cover panel 512 through an adhesive layer BL1, and the rear surface of the touch panel 35 is attached to the liquid crystal panel 511 through an adhesive layer BL2. The touch panel 35 is housed inside a casing 514 along with the liquid crystal panel 511 and the backlight device 513. Even with such a configuration, an external force acting on the outer edge portion 512EP of the cover panel 512 is received by the cover panel support frame 523 and the casing 514, thereby suitably mitigating stress in the vicinity of the outer edge of the liquid crystal panel 511 through the touch panel 35.

### Embodiment 7

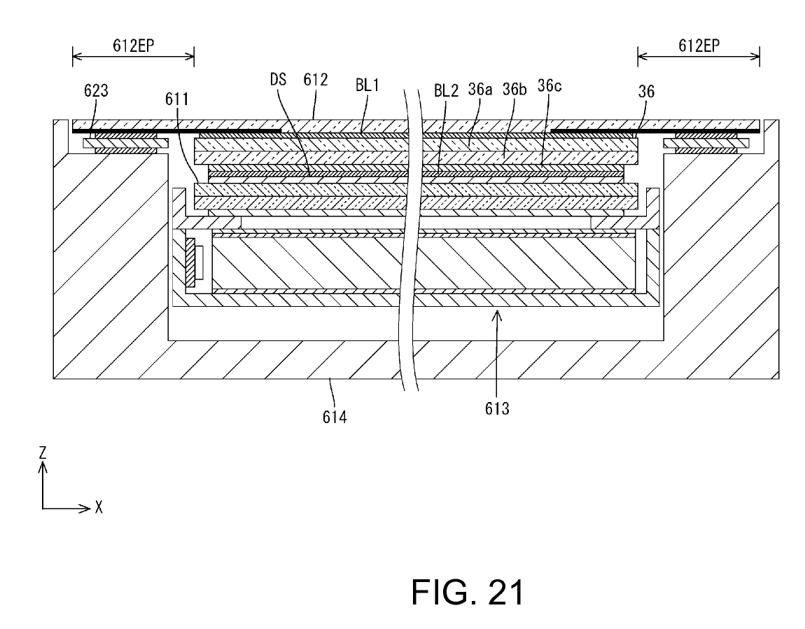

Embodiment 7 of the present invention will be described with reference to FIG. 21. Embodiment 7 additionally includes a parallax barrier panel 36. Descriptions of structures, operations, and effects similar to those of Embodiment 1 will be omitted.

As shown in FIG. 21 the parallax barrier panel 36 is interposed between a liquid crystal panel 611 and a cover panel 612 of the present embodiment. The parallax barrier panel 36 has a parallax barrier pattern (not shown) for allowing a viewer to see a three dimensional image (3D image) by splitting by parallax an image displayed in in the display surface DS of the liquid crystal display panel 611, and functions as a parallax barrier. Specifically, the parallax barrier panel 36 includes a pair of glass substrates 36a and 36b having a horizontally long rectangular shape in a plan view in a manner similar to the liquid crystal panel 611, and a liquid crystal layer (not shown) interposed between the pair of substrates 36a and 36b, and the substrates 36a and 36b are bonded to each other by a sealing member (not shown) formed in a frame shape in a plan view so as to maintain a gap equal to the thickness of the liquid crystal layer. Also, a polarizing plate 36c is attached to the surface of the rear substrate 36b facing outside. The front surface of the parallax barrier panel 36 is attached to the cover panel 612 through an adhesive layer BL1, and the rear surface of the parallax barrier panel 36 is attached to the liquid crystal panel 611 through an adhesive layer BL2. The parallax barrier panel 36 is housed inside a casing 614 along with the liquid crystal panel 611 and the backlight device 613. Even with such a configuration, external force acting on the outer edge portion 612EP of the cover panel 612 is received by the cover panel support frame 623 and the casing 614, thereby suitably mitigating stress on the vicinity of the outer edges of the liquid crystal panel 611 and the parallax barrier panel 36.

### Embodiment 8

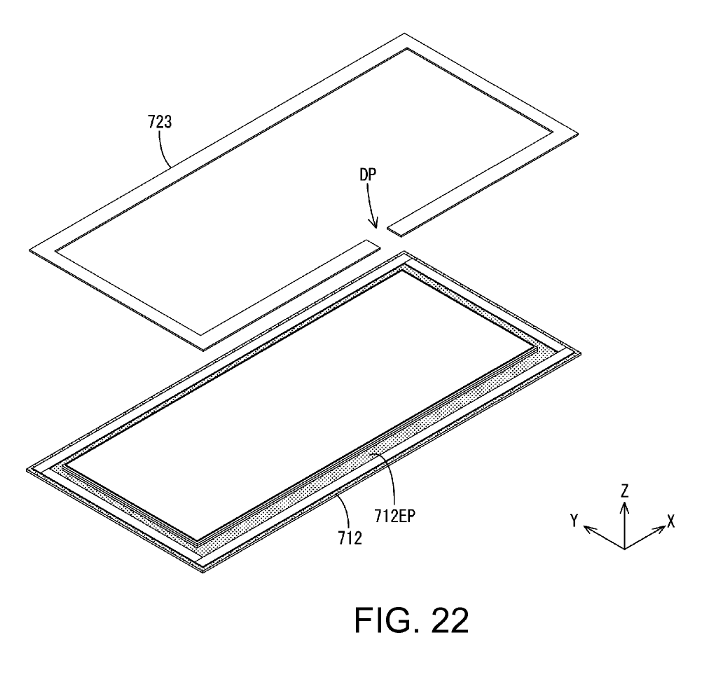

Embodiment 8 of the present invention will be described with reference to FIG. 22. The structure of a cover panel support frame 723 is modified in Embodiment 8. Descriptions of structures, operations, and effects similar to those of Embodiment 1 will be omitted.

As shown in FIG. 22, the cover panel support frame 723 of the present embodiment has a discontinuous loop shape. Specifically, the cover panel support frame 723 has a discontinuity in one of the pair of long sides, to have a discontinuous loop shape while being one part. A disconnection DP in the cover panel support frame 723 is provided in substantially the center in the length direction of the one long side. Even with such a configuration, the cover panel support frame 723 has an overall loop shape, and therefore has sufficient mechanical strength, allowing it to sufficiently receive stress from the outer edge portion 712EP of the cover panel 712.

### Embodiment 9

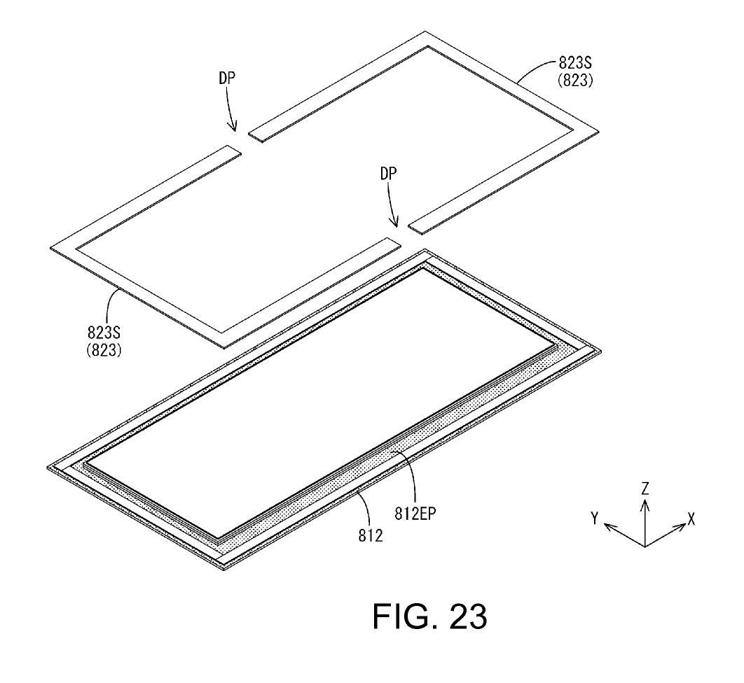

Embodiment 9 of the present invention will be described with reference to FIG. 23. The structure of a cover panel support frame 823 is modified in Embodiment 9. Descriptions of structures, operations, and effects similar to those of Embodiment 1 will be omitted.

As shown in FIG. 23, the cover panel support frame 823 of the present embodiment has a loop shape that is discontinuous in two locations. Specifically, the cover panel support frame 823 has a discontinuous loop shape and includes two separate parts, the disconnections being formed respectively in the pair of long sides. The disconnections DP in the cover panel support frame 823 are formed substantially in the centers in the length direction of the respective long sides. The cover panel support frame 823 includes a pair of separate support frames 823S forming a substantially gate shape in a plan view, and these pair of separate support frames 823S are defined as one item. Even with such a configuration, the cover panel support frame 823 has an overall loop shape, and therefore has sufficient mechanical strength, allowing it to sufficiently receive stress from the outer edge portion 812EP of the cover panel 812.

### Embodiment 10

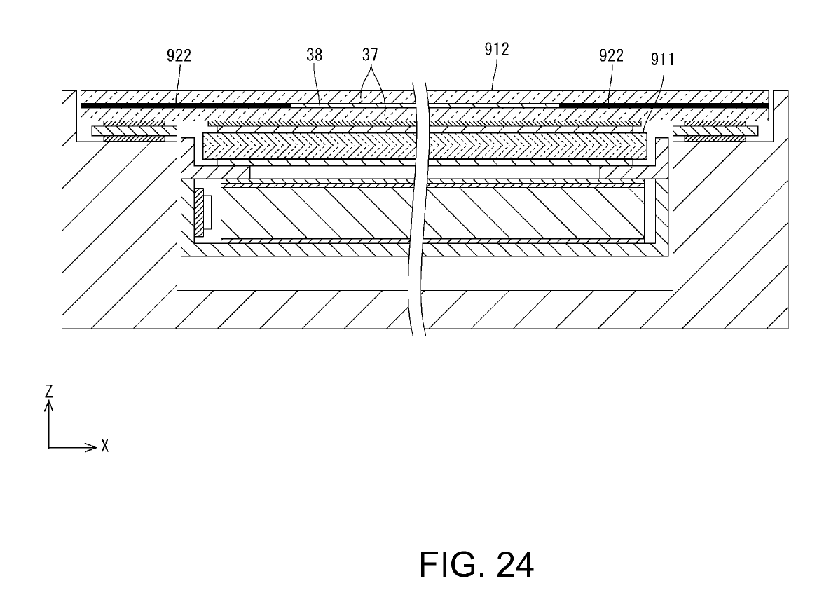

Embodiment 10 of the present invention will be described with reference to FIG. 24. The structure of a cover panel 912 is modified in Embodiment 10. Descriptions of structures, operations, and effects similar to those of Embodiment 1 will be omitted.

As shown in FIG. 24, the cover panel 912 of the present embodiment includes a pair of glass substrates 37 and a film 38 interposed between the glass substrates 37 to form a laminated glass structure. The pair of glass substrates 37 are almost completely transparent and have substantially the same size as each other in a plan view. The film 38 is made of an almost completely transparent synthetic resin, and a light-shielding layer 922 that blocks light is provided on the outer edges thereof. The light-shielding layer 922, as in Embodiment 1, has a substantially frame shape surrounding the display region of the liquid crystal panel 911, and is integrally formed with the film 38 by a printing method such as screen printing or inkjet printing, for example.

### Other Embodiments

The present invention is not limited to the embodiments shown in the drawings and described above, and the following embodiments are also included in the technical scope of the present invention, for example.

(1) In Embodiments 1 and 2, the cover panel support frame and the casing are attached to each other by a bonding layer (adhesive or bonding agent), but another method that can be used is to use a screw member disclosed in Embodiment 3, for example.

(2) In Embodiment 3 above, the cover panel support frame and the casing were attached to each other by a screw member, but another method is to attach these together using a bonding layer (adhesive or bonding agent) disclosed in Embodiments 1 and 2, for example.

(3) Besides (1) and (2), the cover panel support frame and the casing can be attached to each other by fixing by welding or rivets, or engaging using a stopper.

(4) In the embodiments above, the cover panel support frame is attached to the outer edge portion of the cover panel by a bonding layer (adhesive or bonding agent), but this bonding layer can be omitted. Even in such a case, as long as the cover panel support frame is disposed so as to be in contact with the rear surface of the outer edge portion of the cover panel, the external force acting on the outer edge portion can be received by the cover panel support frame.

(5) In Embodiments 2 and 3, the reinforcing portions (first reinforcing portions and second reinforcing portions) are provided on all four sides of the main support frame body, but a configuration in which the reinforcing portions are provided only on some of the four sides of the main support frame body (one, two, or three sides) is also included in the present invention.

(6) In Embodiments 2 and 3, the reinforcing portions (first reinforcing portions and second reinforcing portions) extend along almost the entire length of the edge of the main support frame body, but a configuration in which the reinforcing portions are not formed along the entire length of the edge of the main support frame body is also included in the present invention.

(7) In Embodiments 2 and 3, the first reinforcing portions protrude further out from the main support frame body than the second reinforcing portions, but a configuration in which the second reinforcing portions protrude further out than the first reinforcing portions or in which the first reinforcing portions and the second reinforcing portions protrude an equal amount may be adopted.

(8) In Embodiment 3, a configuration in which the backlight device is fixed in position by the first reinforcing portions being disposed to face the backlight device from the inside was described, but a configuration in which the backlight device is fixed in position by the first reinforcing portions being disposed to face the backlight device from the outside may be adopted.

(9) In Embodiment 3, the first reinforcing portions fix in position both the liquid crystal panel and the backlight device, but a configuration can be adopted in which the first reinforcing portions fix only one of the liquid crystal panel or the backlight device.

(10) In Embodiment 3, the first reinforcing portions are provided with light-shielding portions, but the light-shielding portions may naturally be omitted.

(11) In Embodiment 3, the guide reinforcing portion sandwiches the flexible substrate with the backlight device, a configuration in which the flexible substrate is sandwiched between the guide reinforcing portion and the outer edge of the liquid crystal panel but not between the guide reinforcing portion and the backlight device can be adopted.

(12) In Embodiment 3, the guide reinforcing portion, which has both the function of the first reinforcing portions and of a guide for the flexible substrate, was included, but a configuration may be adopted in which none of the first reinforcing portions have a guiding function for the flexible substrate. Alternatively, if there are a plurality of flexible substrates, a plurality of the first reinforcing portions may double as guide reinforcing portions.

(13) In Embodiment 3, the outer second reinforcing portions can be omitted. Even if the second reinforcing portions are omitted, it is possible for the first reinforcing portions to respectively fix in position the liquid crystal panel and the backlight device.

(14) In Embodiment 5, the reinforcing portion is shown to include only a first reinforcing portion provided on the inner edge of the main support frame body, but a configuration in which the reinforcing portion includes only a second reinforcing portion provided on the outer edge of the main support frame body is also included in the present invention.

(15) In Embodiments 6 and 7, a touch panel or a parallax barrier panel is additionally included and attached to the liquid crystal panel, but both the touch panel and the parallax barrier panel may be additionally included.

(16) In Embodiment 6, the touch panel is provided separate from the cover panel, but a touch panel may be provided instead of the cover panel. In other words, it is possible to form a touch panel pattern on the cover panel to have the cover panel double as a touch panel.

(17) In Embodiment 6, the touch panel pattern on the touch panel was of the projected capacitive type, but besides this, the present invention can be applied to a surface capacitive type, a resistive film type, or an electromagnetic induction type touch panel pattern, or the like.

(18) In Embodiment 6, the parallax barrier panel is provided separate from the cover panel, but a parallax barrier panel may be provided instead of the cover panel.

(19) It is also possible to form a touch panel pattern on the front substrate of the parallax barrier panel disclosed in Embodiment 7 to have the parallax barrier panel double as a touch panel.

(20) In Embodiment 7, a case was described in which a parallax barrier panel that functions to display a three dimensional image to a user was used, but the present invention can be applied to a parallax barrier panel for attaining so-called multi-view functionality in which users located at two or more different viewing angles see different images, for example.

(21) In Embodiment 7, a case was described in which the parallax barrier panel that is a switching liquid crystal panel that can switch between two dimensional display and three dimensional display is used, but a parallax barrier panel that always has a barrier portion such that three dimensional images are always displayed may be used, for example.

(22) Besides what was described in (21), it is possible to have a configuration in which a mask filter having a prescribed light-shielding pattern is formed on either of the substrates constituting the parallax barrier panel to always display three dimensional images such that switching to two dimensional display is not possible.

(23) In Embodiments 8 and 9, configurations were shown in which the one or two disconnections were formed in the long sides of the cover panel support frame, but the number and location of the disconnections in the cover panel support frame can be appropriately modified. For example, it is possible to have the disconnection be formed in the short sides of the cover panel support frame or to have three or more disconnections.

(24) In the respective embodiments above, the cover panel support frame is made of metal, but the cover panel support frame may be made of a synthetic resin.

(25) In the respective embodiments above, the cover panel is made of tempered glass that is tempered by being chemically strengthened, but a tempered glass that is strengthened by air cooling (physical strengthening) may naturally be used.

(26) In the respective embodiments above, a tempered glass being used as the cover panel was shown as an example, but an ordinary glass material (non-tempered glass) can also be used.

(27) In the respective embodiments, a case was described in which an edge-lit backlight device is used in the liquid crystal display device, but a configuration having a direct-lit backlight device is also included in the present invention.

(28) In the respective embodiments, an example was described of a transmissive liquid crystal display device having a backlight device, which is an external light source, but the present invention can also be applied to a reflective liquid crystal display device performing display using external light, and in such a case, no backlight device is needed.

(29) In the respective embodiments above, the display surface is a horizontally long liquid crystal display device, but a liquid crystal display device in which the display surface is vertically long is also included in the present invention. Also, a liquid crystal display device in which the display surface is square is also included in the present invention.

(30) In the respective embodiments above, TFTs are used as the switching element in the liquid crystal display device, but the present invention can be applied to a liquid crystal display device that uses a switching element other than a TFT (a thin film diode (TFD), for example), and, besides a color liquid crystal display device, the present invention can also be applied to a black and white liquid crystal display device.

(31) In the respective embodiments above, a liquid crystal display device using a liquid crystal panel as a display panel was described as an example, but the present invention can be applied to a display device that uses another type of display panel (such as a PDP or organic EL panel). In such a case, a backlight device can be omitted.

(32) In the respective embodiments above, the casing is made of a synthetic resin, but the casing can also be made of metal (aluminum, or magnesium die casting, for example).

### DESCRIPTION OF REFERENCE CHARACTERS

10 liquid crystal display device (display device)

11, 111, 211, 511, 611, 911 liquid crystal panel (display panel)

11a, 11b, 211b substrate

12, 112, 212, 512, 612, 712, 812, 912 cover panel

12EP, 112EP, 512EP, 612EP, 712EP, 812EP outer edge portion

13, 213, 513, 513 backlight device (illumination device)

14, 114, 214, 514, 514 casing (case member)

23, 123, 223, 523, 623, 723, 823 cover panel support frame (cover panel support member)

26, 126, 226 support frame attaching portion (support member attaching portion)

27, 127, 227, 327, 427 main support frame body

28, 228, 328, 428 reinforcing portion

28a, 228a, 328a, 428a first reinforcing portion

28b, 228b, 328b second reinforcing portion

29 flexible substrate

30 guide reinforcing portion (reinforcing portion)

31 control substrate (signal supply substrate)

32 light-shielding portion

220b side plate (positioning portion)

DS display surface

TV television receiver

1. A display device, comprising:
a display panel having a display surface that displays an image;
an illumination device disposed on a rear side of the display panel opposite to the display surface, the illumination device radiating light to the display panel;
a cover panel disposed to cover the display surface of the display panel, the cover panel having an outer edge portion disposed farther out than an outer edge of the display panel; and
a cover panel support member having a substantially loop shape along the outer edge portion and being disposed on a same side of the outer edge portion of the cover panel as the display panel, the cover panel support member being not a part of at least the illumination device.

2. The display device according to claim 1, further comprising:
a case member housing at least the display panel and the illumination device,
wherein the case member is provided with a support member attaching portion to which the cover panel support member is attached, the cover panel support member being sandwiched between the outer edge portion of the cover panel and the support member attaching portion.

3. The display device according to claim 1, wherein the cover panel support member is formed in a continuous loop.

4. The display device according to claim 1, wherein the cover panel support member includes a main support member body having a substantially loop shape while being parallel to the outer edge portion, and a reinforcing portion that protrudes in a direction intersecting with a surface of the cover panel from an edge of the main support member body along the outer edge portion.

5. The display device according to claim 4, wherein the reinforcing portion includes a first reinforcing portion that protrudes from an inner edge of the main support member body, the inner edge being relatively close to the display panel, and a second reinforcing portion that protrudes from an outer edge of the main support member body, the outer edge being relatively far from the display panel.

6. The display device according to claim 4, wherein the reinforcing portion is formed along almost an entire length of the edge of the main support body.

7. The display device according to claim 4, wherein the reinforcing portion protrudes from the edge of the main support member body towards a direction opposite to where the cover panel is provided.

8. The display device according to claim 7, wherein the reinforcing portion protrudes from at least the inner edge of the main support member body, the inner edge being relatively close to the display panel, the reinforcing portion facing outer edges of the display panel while being adjacent thereto.

9. The display device according to claim 8, wherein the reinforcing portion is provided with a light-shielding portion that extends inward along a surface of the display panel, the light-shielding portion blocking light from the illumination device by being interposed between the outer edges of the display panel and the illumination device.

10. The display device according to claim 8 , wherein the illumination device is provided with a positioning portion disposed to face the reinforcing portion while being adjacent thereto from outside the reinforcing portion.

11. The display device according to claim 8,
wherein the reinforcing portion includes a first reinforcing portion that protrude from an inner edge of the main support member body, the inner edge being relatively close to the display panel, and a second reinforcing portion that protrude from an outer edge of the main support member body, the outer edge being relatively far from the display panel, and
wherein the first reinforcing portion protrudes farther out from the main support member body than the second reinforcing portion.

12. The display device according to claim 4,
wherein one end of a flexible substrate for transmitting image signals is connected to the display panel, and
wherein the reinforcing portion sandwiches the flexible substrate with the outer edges of the display panel.

13. The display device according to claim 12,
wherein a surface of the illumination device opposite to a surface facing the display panel is provided with a signal supplying substrate that supplies the image signals to the flexible substrate, another end of the flexible substrate being connected to the signal supplying substrate, and
wherein the reinforcing portion sandwiches the flexible substrate with the illumination device.

14. The display device according to claim 1, wherein the cover panel support member is made of sheet metal.

15. The display device according to claim 1, wherein the display panel is a liquid crystal panel including a pair of substrates with liquid crystal sealed therebetween.
